(19) United States
(12) Patent Application Publication
(10) Pub. No.: US 2024/0246350 A1
(43) Pub. Date: Jul. 25, 2024

(54) SYSTEMS AND PROCESSES FOR PRODUCING PROMOTIONAL PRODUCTS WITH VARIABLE DATA PRINTING HAVING AN INFORMATIONAL PANEL, ENVELOPING CARRIER PANEL, AND UNIQUE I.D., TRANSACTIONABLE GIFT CARD ATTACHED THERETO

(71) Applicant: John Nader, Valparaiso, IN (US)

(72) Inventor: John Nader, Valparaiso, IN (US)

(21) Appl. No.: 18/420,398

(22) Filed: Jan. 23, 2024

Related U.S. Application Data
(60) Provisional application No. 63/481,087, filed on Jan. 23, 2023.

(51) Int. Cl. B42D 15/04; G06Q 20/34

(52) U.S. Cl. CPC B42D 15/045; G06Q 20/354

(57) ABSTRACT

Systems and processes for producing a hybrid promotional product having an informational panel, an enveloping carrier panel, and at least one transactionable gift card secured thereto. A blank is created having a card panel and an enveloping carrier panel that are contiguous with a fold line therebetween. The enveloping carrier panel is detachable and designed such that it defines enveloping panels and provides means for enclosing a card secured therein by folding the enveloping panels onto each other. The enveloping carrier panel may be secured in such an enclosing configuration by inserting portions of the enveloping panels into aligned slots defined in adjacent enveloping panels once folded. A card enclosed therein may be a gift card, requiring activation and card monetization by an initial recipient at a transaction website after which the card may be redeemed by an end user. The card, enveloping carrier panel, or informational panel provide unique I.D dynamic VDP information.

### CROSS REFERENCE TO RELATED APPLICATIONS

This application claims the benefit of U.S. Patent Application No. 63/481,087, filed Jan. 23, 2023, the contents of which are incorporated herein by reference.

### STATEMENT REGARDING PRIOR DISCLOSURES BY THE INVENTOR OR A JOINT INVENTOR

This application is related to U.S. Pat. No. 11,034,143 by the present inventor, the contents of which are incorporated herein by reference.

### BACKGROUND OF THE INVENTION

The present invention generally relates to sheet products and processes therefor. The invention particularly relates to processes for producing sheet products comprising surface-mounted or applied gift cards enclosed within an enveloping carrier panel manufactured along with additional informational panels from a single, fully-integrated contiguous paper blank, and to products formed thereby.

Demand has continued to grow for direct mail advertising. Direct mail, that is, advertising mail products that are directly addressed to the intended recipient, encompasses a wide variety of marketing materials, including brochures, catalogs, postcards, newsletters, and sales letters. These promotional products are designed to convey personalized purchase offers and information to postal or otherwise distributed recipients. In the direct mail advertising industry, there is a growing demand for high quality, standalone, personalized direct mail promotional products that provide customers with redeemable discount offers, loyalty promotions primarily used at point of purchase retail outlets, and/or embedded or non-embedded electronic labels/tags that enable the recipient to be immediately connected via a mobile phone or computer. Increasingly, these promotional products have non-trackable or trackable data usage measurements suitable for providing the direct mail retail advertisers with closed-loop data feedback regarding the success of their direct mail advertising campaigns.

Demand also continues to grow for gift cards, which are often purchased and value-activated at a point of sale (POS) retail outlet and often displayed and sold as a generic plastic card attached to a cardboard sleeve. Such “closed loop” gift cards (meaning originated by a specific retail merchant for use on only the merchant's brand) typically enable the possessor to make purchases at particular businesses (merchants) and perhaps for particular products offered by those businesses, but are otherwise impersonal, inconvenient to obtain for a consumer because a trip to a gift card retailer is required to obtain the gift card, and purchase options are generally limited to large national retail establishments. As an alternative to physical gift cards, businesses may opt to issue electronic gift cards, but such non-physical cards are sometimes perceived as non-tangible and remain impersonal and awkward for many to give and receive.

In view of the above, it would be desirable to provide a more convenient method of offering and distributing gift cards, especially to enable the underserved small business market to offer gift cards in small quantities at a much lower cost than traditional gift card purchase and display methods. It would also be desirable if small businesses could advertise at a point of sale with an option to take home and activate gift cards that include an envelope that is contained within one convenient brochure. Small business retailers have the ability to mail to local geographic or demographic markets within a localized territory near the small business. In either case, it would be desirable if a retailer were not only able to distribute but also advertise, and recipients were also able to keep on hand an option to activate, monetize and gift to another individual at the recipient's convenience or need and only at will if and when the recipient chooses to do so.

FIGS. 1A-1F represent nonlimiting examples of various card based promotional products 10 that carry promotional add-ons, for example, paper cards 12 offering redeemable discounts or loyalty promotions, which are attached to a multi-page carrier 14. These promotional products 10 typically have direct mail advertising print formats widely used by commercial retail as high-end promotional coupons, redemptions, or loyalty cards. Promotional cards 12 and carriers 14 of this type were often manufactured by one of two general methods, one being web finished from a continuous fully, partially, or non-preprinted web from a web printing press combined with inline or separate stand-alone “offline” web finishing systems, and the other being methods whereby pre-cut and separately manufactured plastic or paper cards are individually tipped on, on-serted or placed onto a fully, partially, or non-preprinted individual sheet carrier or “blank.” Along with established inherently high volume, elaborate web press printing and finishing methods in which cards and carriers are derived directly from a continuous web, “on-serting,” “on-setting,” “tip-on,” “tipping,” “affixing,” and/or “pick and place” techniques are also widely used and popular methods to attach pre-cut individual cards onto either continuous webs or pre-cut individual carriers. These “card with carrier” manufactured promotional products 10 are some of the most popular and desirable formats in direct mail printing today.

Conventional techniques for producing promotional products of the type represented in FIGS. 1A-1F include creation of individualized cards 12 from paper or plastic (e.g., PVC), which can be added to a running inline or offline web finishing process, or more popularly onto individual separated conveyed pieces from a variety of mailing machines available to the mailing/finishing/fulfillment industry segment. Such cards 12 are attached to their carriers 14 during the finishing process such as by the aforementioned on-serting, on-setting, tip-on, tipping, affixing, and/or pick and place techniques using dedicated machines or feeders for in-time “tip-on” placement of the cards 12 to the carriers 14 (a web or individual piece) conveyed below the machine or feeder. However, these methods also have significant limitations and negative aspects. For example, relative to paper cards, plastic cards have significantly higher material costs, are more costly to print, are of differing paper or print quality, are of differing color match and with greater importance now noted as being environmentally unfavorable to work with and dispose. In addition, these methods typically involve a multi-step process to complete finished card/carrier formats, including separate printing of carriers 14, separate printing of cards 12, separate cutting of carriers to final size, separate die cutting and matrix removal around cards, and sometimes separate process for variable data printing (VDP) onto cards, each of which results in costly additional processes and handling. Regardless of the manufacturing method (e.g., continuous web/ribbon processes, web tip-on, or sheet/blank tip-on methods), in most known existing production circumstances, cards are completely and physically separated from carriers at some point during the process, which results in additional finishing sequences, steps, handling, limitations to product design, and a potential for circumferential and lateral misregistration and graphics mismatch of the card 12 to the carrier 14, as well as speed reduction in finishing. However, most significant errors are likely to occur from the potential disruption of the postal sortation sequence to mailing order and customer receipt of mismatched variable data print and information. The latter issues typically require investment in expensive camera verification technology to “read/write” VDP sequences during reassembly of the card to the carrier to ensure data match and sequencing for client and product recipient.

On the other hand, despite the previously described advantages conferred by single- or multi-ply paper cards relative to plastic cards, paper cards often provide less durability than plastic cards when transported, delivered, or retailed. Providing a carrier that completely envelopes a paper card could provide sufficient protection to mitigate this disadvantage. However, such an enveloping carrier requires complex folding, slitting, and scoring when being produced. The carrier is therefore typically produced in a separate manufacturing process from the card, which contributes to increased production and material costs, as well as contributing to potential data and information mismatches between the card and the enveloping carrier, therefore either requiring additional costs and oversight to ensure proper sorting or exposing the issuer to risk that the promotional materials enclosed therein are not specific to the recipient, thereby degrading their usability and effectiveness. More recently, U.S. Pat. No. 11,034,143 discloses another production method for producing the aforementioned promotional product formats and descriptions that includes components of the aforementioned card and carrier production methods.

In view of the above, it can be appreciated that problems, shortcomings, or disadvantages associated with direct mail products that carry promotional cards would similarly arise when attempting to manufacture and deliver gift cards. It would be desirable if systems and processes were available that were capable of at least partly reducing the complexity of manufacturing processes, reducing make-ready time, and reducing waste associated with the manufacture and delivery of gift cards. In light of the advantages of being able to offer paper gift cards, rather than plastic gift cards, directly to recipients, and the desire to personalize those gift cards for the recipients, it would be advantageous to produce an enveloping carrier panel for a paper gift card in the same manufacturing process and from the same contiguous blank.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, systems and manufacturing processes suitable for producing products that have surface-mounted or applied single- or multi-ply redeemable retail gift cards which can be activated and enclosed within an enveloping carrier panel manufactured along with additional informational panels from a single, fully-integrated contiguous paper blank, and to products formed thereby. The processes preferably reduce the complexity of the manufacturing process, reduce make-ready times, and reduce waste relative to conventional manufacturing processes for producing comparable products.

According to a nonlimiting aspect of the invention, a process is provided for manufacturing a finished, mail-ready product having an enveloping carrier panel, at least one card secured thereto, and an informational panel. The process preferably (though not necessarily) includes providing a single, individual, contiguous blank having images or text printed thereon and at least a first card panel, a first enveloping carrier panel, and a first informational panel that are contiguous with fold lines between each of these panels. The process includes scoring the enveloping carrier panel to define at least one fold line that define folding enveloping panels. Furthermore, the process may include slitting the enveloping carrier panels such that the slitting defines tabs and slots through which the tabs pass, thereby securing the folding enveloping panels in a configuration such that they enclose a card placed therein.

A process according to the aforementioned aspects may further include cutting the first card panel to at least partially define a first partial cutout card therein such that the first partial cutout card remains partially attached to the first card panel and a first remaining portion of the first card panel surrounds the first partial cutout card, folding the first card panel over and onto the first enveloping carrier panel such that the first partial cutout card is secured to the first enveloping carrier panel with an adhesive, and removing the first remaining portion of the first card panel so that the first remaining portion is separated from the first partial cutout card, the first partial cutout card remains secured to the first enveloping carrier panel and defines at least a portion of the card of the product, and the first enveloping carrier panel defines at least a portion of a carrier of the product. Preferably, the card and enveloping carrier panel are never physically separate or out of contact with one another throughout the process.

A process according to the aforementioned aspects may optionally include separating the informational panel from the enveloping carrier panel, thereby defining the informational panel. The informational panel is preferably printed in the same process as the card and enveloping carrier panel, thereby conferring advantages associated with recipient-specific, unique I.D., referring to a code such as QR, UPC or any other type alphanumeric scannable and usable code which is digitally printed dynamically and is unique for each individual card and recipient as part of a variable data printing process VDP, without the accompanying need for intensive sorting or oversight. The card, enveloping carrier panel, and the informational panel providing dynamic and unique I.D. VDP capabilities are preferably never physically separate or out of contact with one another throughout the process.

A process according to the aforementioned aspects may also include folding the enveloping carrier panel in accordance with the fold lines defined previously, and securing the folding enveloping panels once folded in accordance with the tabs and slots defined previously. In a nonlimiting example, a lowermost enveloping panel may be folded upwards over a middle enveloping panel on which a card is placed, and its corners may be fitted into slots previously defined within the middle enveloping panel. A topmost enveloping panel may then fold down over the middle enveloping panel, again being secured to the middle enveloping panel by fitting edges, corners, tabs, or some other element previously defined into the slots of the middle enveloping panel.

A process according to the aforementioned aspects may optionally be modified to provide an enveloping carrier panel having enveloping panels, including a lowermost panel, a lower middle panel, an upper middle panel, and a topmost panel defined by three horizontal folding lines and therefore allowing carriage of two cards, one card located in each of the middle panels. Further modifications may include different configurations of tabs, slots, and folds to enable various enveloping panels to be secured to each other, thereby enclosing the card and in various manners. There are many possible configurations of folds, edges, corners, tabs, slots, or other elements in order to achieve the intended effect, and such configurations may be modified based on the product end state desired by the card retailer, the card issuer, or the card recipient. Furthermore, the processes herein which produce the aforementioned tabs, folds, edges, tabs, and slots may be performed at any time or place in the aforementioned process, again depending on a product end state desired by the retailer, the card issuer, or the recipient.

In the aforementioned aspects of the invention, the card may be a “gift card,” as is commonly known by both consumers, retailers, issuers and those skilled in the aforementioned arts. Such a gift card is typically redeemable for some cash value with a retailer, allowing a recipient to purchase goods with the retailer or issuer to some maximum value. As is known to those with knowledge of the art of retail and marketing, gift cards provide advantages in marketing and retail.

According to another aspect of the invention, a system for producing a product having an enveloping carrier panel and at least one card secured thereto includes means for performing one or more of the steps of the processes described above.

Technical effects of the invention as described above include the ability to manufacture products having at least one informational panel and one or more cards secured to at least one enveloping carrier panel, wherein the informational panel, enveloping carrier panel, and card(s) attached thereto can be produced from a single integral blank, as opposed to an extensive continuous web manufacturing operation (though it should be noted that the blanks can be derived initially from sheets originating from a web printing press). It is believed that, by forming the card and the enveloping carrier panel from the same integral blank with the card being secured in some manner to the enveloping carrier panel at all times in the manufacturing process, any images, text, personalized data, or other printings on the informational panels, enveloping carrier panels, and cards will match without the need of a camera system, verification equipment, or other tracking or timing techniques, which are ordinarily required by conventional web printing techniques and particularly any other on-serting processes that involve separated informational panels, cards, and enveloping carrier panels, therefore requiring matching and combining informational panels, cards, and enveloping carrier panels in later stages of the manufacturing process.

An advantageous effect of the invention is the ability to optionally include personalized, multi-page informational panels, possibly including graphics, advertisements, and/or preferred methods of redemption, including but not limited to user-specific unique I.D. and/or dynamic QR codes and barcodes provided by VDP, along with a gift card or any other type of card that is transactional and redeemable for value with the retailer or issuing party, and a method of enveloping the gift card. Such a method of presentation and delivery provides advantages in marketing and retail, and the method of manufacture reduces costs associated with production and quality control.

Other aspects and advantages of this invention will be appreciated from the following detailed description.

### BRIEF DESCRIPTION OF THE DRAWINGS

FIGS. 1A-1F represent promotional products having a variety of direct mail formats and cards of various quantities, shapes, sizes, and configurations attached thereto.

FIG. 2 represents a system and stations thereof that are suitable for performing the steps of FIGS. 3A-7B, 11A, 11B, 15, and 16 in accordance with aspects of the present invention.

FIGS. 3A through 3F represent steps of a manufacturing process for producing a promotional product, represented in a single card format as a nonlimiting example, with a card attached thereto.

FIG. 4 represents a nonlimiting promotional product of a type that can be produced by the manufacturing process depicted in FIGS. 3A through 3F.

FIGS. 5A, 5B, 6A-6C, 7A, and 7B represent steps of alternative manufacturing processes for producing different types of promotional products, each represented in a single card format as nonlimiting examples, with a card attached thereto in accordance with nonlimiting embodiments of the present invention.

FIGS. 8 and 9 represent exemplary stations that may be used in conjunction with a waste removal station of the system represented in FIG. 2

FIG. 10 represents a system and stations thereof that are suitable for performing the steps of FIGS. 11A through 17B in accordance with aspects of the present invention.

FIGS. 11A and 11B represent two nonlimiting alternative embodiments of a non-scaled promotional product, represented in a two-card format as a nonlimiting example, and representing two different configurations of scores and slits to define an enveloping carrier panel for, respectively, a four-panel gift card envelope and a three-panel gift card envelope. Directional scoring and slitting are applied to an enveloping carrier panel and informational panel in order to define a lowermost enveloping panel, lower middle enveloping panel, upper enveloping panel, and possibly a topmost enveloping panel depending on the desired configuration of the enveloping carrier panel.

FIG. 12 represents the enveloping carrier panel, represented in a two-card format as a nonlimiting example, with gift cards attached thereto and the informational panel remaining attached to the enveloping carrier panel.

FIG. 13 represents the informational panel being detached from the enveloping carrier panel by an initial recipient. Following gift card monetization and activation by the initial recipient, the enveloping carrier panel is then folded and secured by the initial recipient, thereby securing a newly activated gift card within the enveloping carrier panel. The informational panel and second “promotional” card if included in product, may be discarded or retained by the initial recipient for later use or reference.

FIGS. 14A-14F represent a nonlimiting folding technique whereby the initial recipient may fold the four-panel enveloping carrier panel of FIG. 11A, thereby securing the gift card within the enveloping carrier panel.

FIGS. 15 and 16 depict additional nonlimiting enveloping carrier panel format design examples. FIG. 15 shows a 3-panel envelope from an irregular shaped blank with a “flap/latch” used for envelope closure, while FIG. 16 shows a 2-panel envelope from irregular shaped blank with each version eventually folding around and containing a gift card within.

FIG. 17A represents the temporary removal of the gift card by initial recipient to allow access to unique I.D. QR or other code for internet activation using cell phone camera or computer, while FIG. 17B represents gift card replacement back onto enveloping carrier panel following activation and prior to folding of enveloping carrier panel around card.

### DETAILED DESCRIPTION OF THE INVENTION

The intended purpose of the following detailed description of the invention and the phraseology and terminology employed therein is to describe what is shown in the drawings, which depict and/or relate to one or more nonlimiting embodiments of the invention, and to describe certain but not all aspects of the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended provisional claims, and not the detailed description, are intended to recite what at least provisionally are believed to be aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of a process for producing a promotional product with a gift card attached to and enclosed within at least one enveloping carrier panel and accompanied by at least one informational panel as represented in the drawings. All such relative terms are useful to describe the illustrated embodiment(s) but should not be otherwise interpreted as limiting the scope of the invention. For convenience, consistent reference numbers are used throughout the drawings to identify the same or functionally equivalent elements.

Processes and/or systems in accordance with certain principles of the invention preferably provide an economical, single-pass finishing method and technique to produce a “hybrid” direct marketing product as a standalone VDP informational and promotional advertising brochure containing a fully transactionable gift card including a corresponding gift envelope. The gift card and gift envelope can be distributed to recipients for convenience, usage choice, and timing of use as recipient self-activated while promoting the issuing retailer's business. Prior to finishing, the process offers the ability to use full color VDP on each individual “blank” to provide for targeted personalization and ensure data integrity within each individual product. Distribution to an initial recipient can be through any convenient mode, such as postal service delivery, at point of sale (POS), or as part of a delivery or package. Gift card monetized activation is determined by the initial recipient at a time and place of convenience to the initial recipient, and an optional gifting envelope may be included for receipt by an end user of the gift card.

A single pass finishing process in accordance with certain principles of the invention typically can be completed in seconds and creates a product unrealized in the marketplace as a stand-alone, mail ready or consumer ready product, while comparable offerings include purchasing or making cards, multitask printing of gift cards and advertisement brochures, gathering individual components, and data matching of components and envelope inserting of components to create a mailer. In contrast, the traditional form of physical gift card giving requires the separate manufacture of a gift card being on-serted, tipped-on, or placed onto a cardboard carrier or sleeve and enclosed as a final package for display and sale at a retail store. The traditional gift card manufacturing process relates to separately producing a card often from PVC, requiring print images, variable barcodes, alphanumeric codes, and/or magnetic stripes which must be encoded then electronically verified and security codes of which there are numerous well established production methods known by those familiar with the industry. Gift cards with cardboard or some more embellished carrier sleeves are purchased from a display rack and must be monetized and activated at the time of purchase prior to leaving the store. A gift card envelope or secondary card may typically be purchased for presentation of the gift card to an end user of the gift card.

According to certain aspects of the invention, the manufacturing processes described hereinafter are typically capable of substantially replicating promotional products produced from paper from a large variety of commonly available equipment and processes capable of on-serting, on-setting, tip-on, tipping, affixing, and/or pick and place techniques commonly employed to attach separated individual gift cards to enveloping carrier panels. Generally, such promotional products can be produced using a system having aspects in common with folder/gluer lines of the type used in the folding carton box converting industry to finish promotional products. In addition, such promotional products can be reproduced from high quality printing materials by processes that can be configured to maximize efficiency, time, and/or material cost savings while reducing waste relative to previous methods. The manufacturing processes described herein are further believed to address a growing print buyer demand for production of high quality and high value-added promotional products at reduced qualities by providing lower quantity runs at reduced cost relative to conventional methods.

While the invention is particularly well suited for producing promotional products for reasons as described above and will be discussed below in reference to such products, the invention is not limited to promotional products or to any particular material from which such products may be produced. In particular, though the invention will be described hereinafter in reference to promotional products of types generally used for direct mail advertising campaigns, it will be appreciated that aspects of the present invention are specifically applicable to retailed promotional, transactionable “gift” cards. For example, processes disclosed herein may be used to produce single- and multi-ply gift cards having cards surface-mounted to an enveloping or non-enveloping carrier panel or later enclosed within an enveloping carrier panel. Simplex and duplex variable data printing (VDP) may be used to apply trackable or non-trackable data and/or digital tags, stickers, labels, etc., outside of or within layers of plies used to create the cards (or other product). A unique I.D. and/or dynamic QR codes, UPC, or any other type of barcode (such that the term “unique ID.” is used herein to refer to a code such as QR, UPC or any other type alphanumeric scannable, or otherwise readable and usable code which is digitally printed dynamically, referring to ever changing per each product within a continuous production sequence) is a unique identifier for each individual card and recipient as part of a VDP process, digital tags, NFC (near field communications), magnetic strips, and RFID (radio frequency identification) and magnetic ink-printed circuits, and other compatible types of physically attachable data carriers are nonlimiting examples of what may be used to link the products with electronic devices to expand a user's interaction and experience. Digital tags, stickers, unique and dynamic QR codes, barcodes, magnetic strips, NFC or RFID devices, labels, and/or other physically affixable data carriers may be applied to a blank prior to or during processing to be conspicuous (external) or inconspicuously embedded (internal) within layers or plies that create the product. Such data carriers may be affixed to further enhance value-added, security and interactive user capabilities and create direct digital interactivity useful for gift card activation and redemption. As known in the art, VDP may be monochrome or partial, single, or full color, may be used to affix (e.g., by printing) magnetic ink-printed circuits, and may be of any quality (including photo) that can be produced by available methods, including digital laser, digital inkjet, digital toner, or other variable print methods. Unique and dynamic VDP may also be used to apply trackable or non-trackable barcodes, QR, UPC, magnetic ink-printed circuits, alphanumeric I.D. codes or sequences, addresses, data, etc.

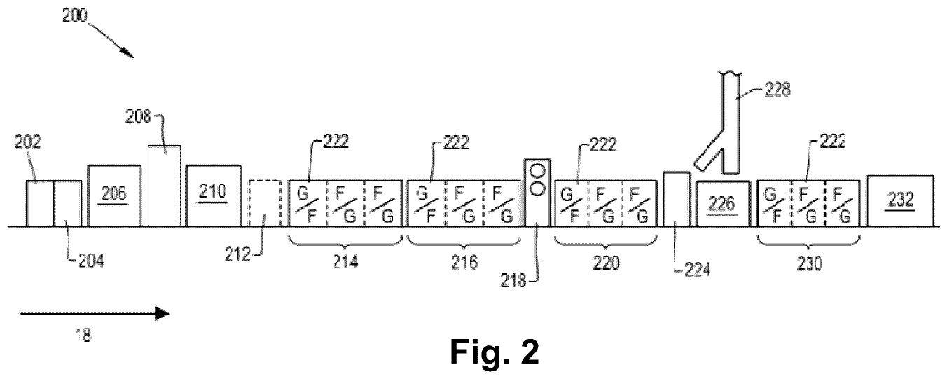

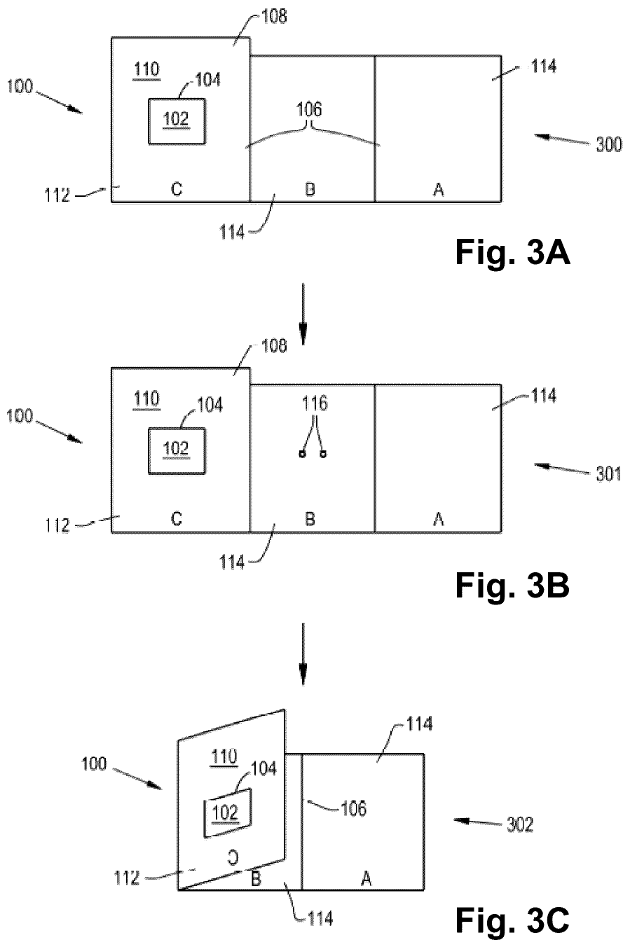

FIGS. 3A-7B represent nonlimiting examples of promotional products and processing steps that may be employed to produce such products, and FIG. 2 schematically represents a system 200 adapted for use in such processes.

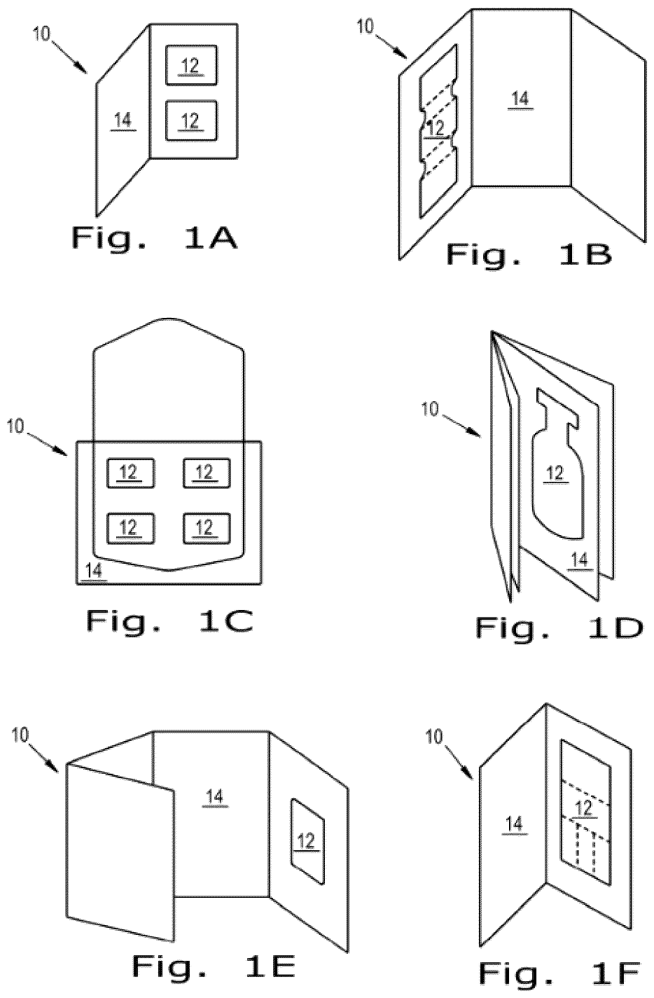

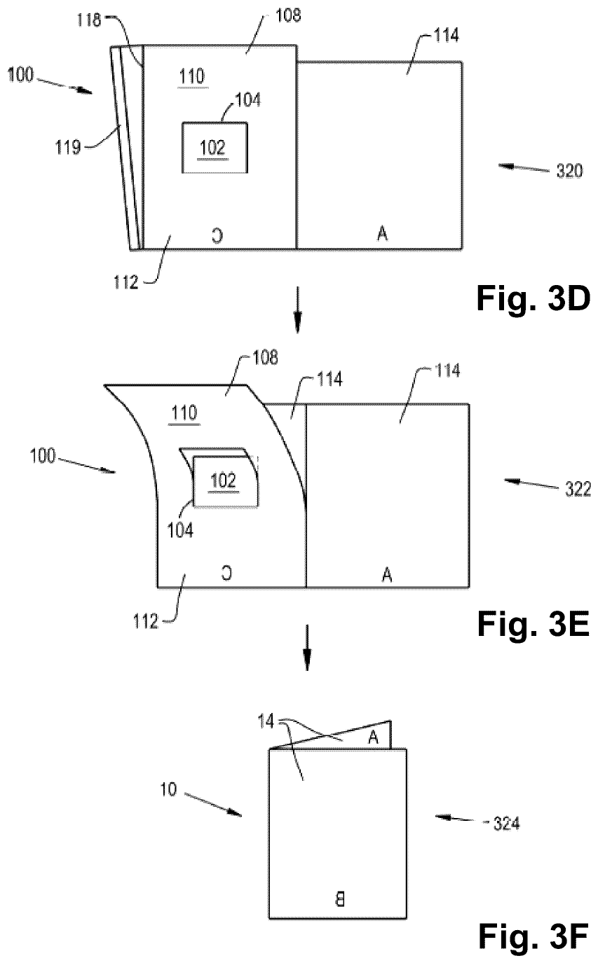

As shown in FIG. 2, the system 200, which may be referred to as a folder/gluer system or line, is particularly configured for producing single- and multi-ply promotional products from single, individual, fully integrated (contiguous) preprinted or non-preprinted blanks (substrates) 100, nonlimiting examples of which are represented in FIGS. 3A-3F and 5A-7B. As used herein and consistent with its general meaning in the printing industry, the term “blank” does not refer to the absence of printing or images, but instead refers to a cut-out or otherwise individual final sized and flat dimensioned, substrate ready for gluing and/or folding before or after in a printing process. As such, “blank” refers to an individual article that may or may not be created within the system 200 as part of a continuous web or individual larger sheets containing one or more blanks. The system 200 is represented in FIG. 2 as including a feeder station that may comprise a feeder unit 202 and an edge guide unit 204, followed by optional VDP stations 206 and 210 that apply individualized data to the blanks 100, an optional turnover unit 208, one or more optional “additions” stations 212, multiple folding stations 214, 216, 220, and 230 (each of which may include a gluing unit 222), one or more optional mid-line die cutters 218, a “slitting” station 224, a waste separation station 226 where waste separation occurs, a waste evacuation system 228, and a “postal-ready” station 232. In general, as represented the system 200 is configured to convey, VDP image, flip, on-sert, fold, glue, die cut, slit, score and shingle/stack the blanks 100 in order to produce the final products, such as but not limited to the promotional (direct mail) products 10 of FIG. 1, as well as a nonlimiting example of a promotional product 10 schematically represented in FIG. 4. For convenience, identical reference numerals are used in FIG. 4 to denote the same or functionally equivalent elements described for the products 10 of FIG. 1, i.e., a gift card 12 (sometimes simply referred to herein as a card 12) mounted to a carrier 14.

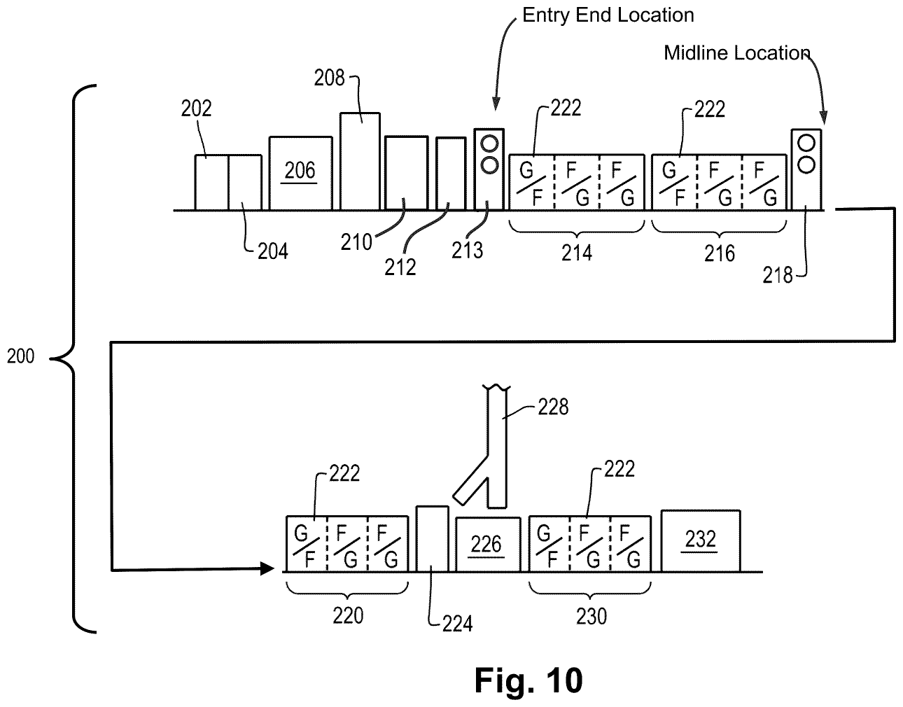

As will become evident from the following discussion, the product 10 is representative of single-ply and multi-ply promotional products that can be produced by manufacturing process steps represented in FIGS. 3A-3F and 5A-7B. While the system 200 is represented in FIG. 2 as comprising certain stations, units, etc., as noted above, other systems could be used that could include fewer or additional stations, units, etc. Furthermore, there are many variations in how and in what sequence certain operations may be performed, and various hybrid executions are foreseeable. For example, VDP may be performed with a roll-fed (web) or sheet-fed press, and performed partially or entirely within one or more of the folding stations 214, 216, 220, and 230, etc. Similarly, blank and/or card creation may be performed with one or more die cutters (e.g., a die cutting unit 213 represented in FIG. 10) located at an entry end location to one or more of the folding stations 214, 216, 220, and 230, at which point the blanks 100 may be individual sheets or portions of a web, for example, a sheet-fed printing press or a web printing press could directly feed a rotary die cutter (e.g., 213) to cut the blanks 100 immediately before feeding the blanks 100 directly into the first folding station 214, 216, 220, or 230.

Promotional products may be initially preprinted by applying images to a sheet or web using any printing means known or developed in the art, such as but not limited to a fixed repeat rotary sheet fed offset, web fed offset, digital, inkjet, digital toner, flexographic, rotogravure or other type of printing press, as well as hybrids of any combination thereof. Printed sheets may have an approximate finished size of typically 1, 2, 3, 4 or 5 up/around, but can be any multiple of repeat images that fit into a rotary press repeat circumference. Preprinted sheets or a printed web may comprise completely variable images printed from a non-cylindrical inkjet, laser, digital toner, or any other spray-on ink transfer printing method and specifically delivered sheeted as individual sheets into a receding pile, conveyor table, or other delivery. Printing may include one or both sides of a sheet or web and can include any ink color additions or sequence, UV cured coatings, aqueous coatings in any image pattern or area, or other application known in the art.

A particular but nonlimiting example of the above is to position the system (folder/gluer line) 200 immediately and directly following a printing press, which may utilize any print engine technology available and produce from sheet to sheet or roll to sheet a final cut preprinted blank 100 having any suitable format size for producing the intended card(s) 12 and carrier 14. The cutting operation that produces the blank 100 may take place at the exit of the press, or may take place at the entry of the system 200 or anywhere thereafter prior to a folding operation and therefore within a continuous “inline” blank conveyance and operation. As such, the system 200 is capable of being combined with a wide variety of printing presses and systems.

As a particular but nonlimiting alternative to the above, images can be applied to printed or non-preprinted blanks 100 after they have entered the system 200. Any suitable printing means can be employed to perform any portion or the entirety of the printing operation(s) performed to produce the product 10.

In particular embodiments, portions of a sheet or web that will later form the cards and carriers of the promotional products are preferably printed side-by-side and laterally across the width of the sheet or web, such that blanks formed therefrom, which in the nonlimiting examples illustrated in the drawings are represented by the aforementioned individual integral blanks 100 of FIGS. 3A-3F and 5A-7B, may later be folded to produce the finished promotional products (such as the product 10 of FIG. 4). Preferably, VDP is performed prior to gluing and folding the blanks 100, but may be performed at any time with or during initial printing operations and/or after a blank 100 has been folded within the system 200. Other additions to the blanks 100 may be added at any time within the system 200 to enhance the value of the promotional product.

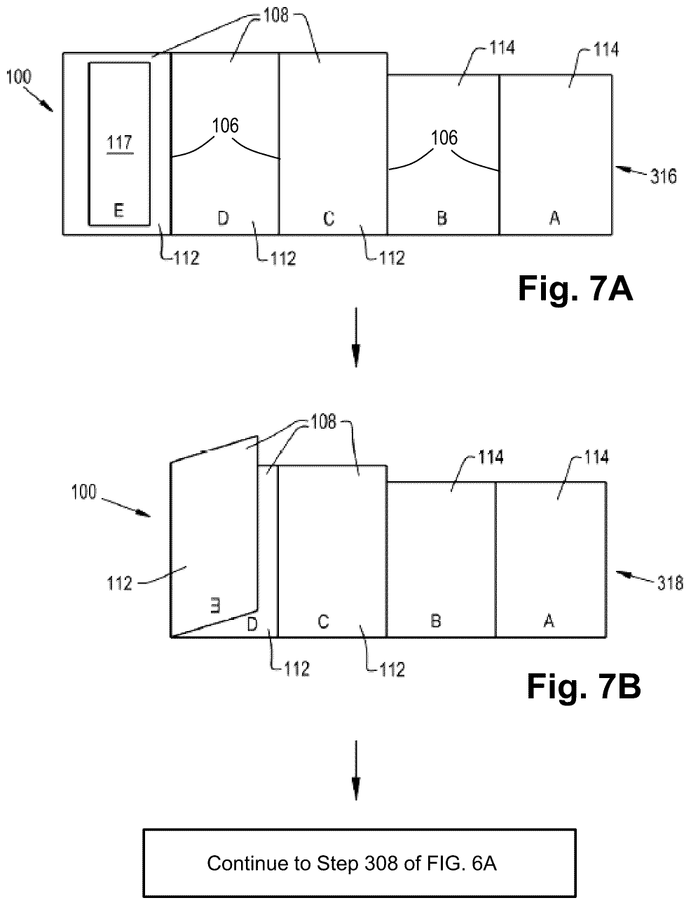

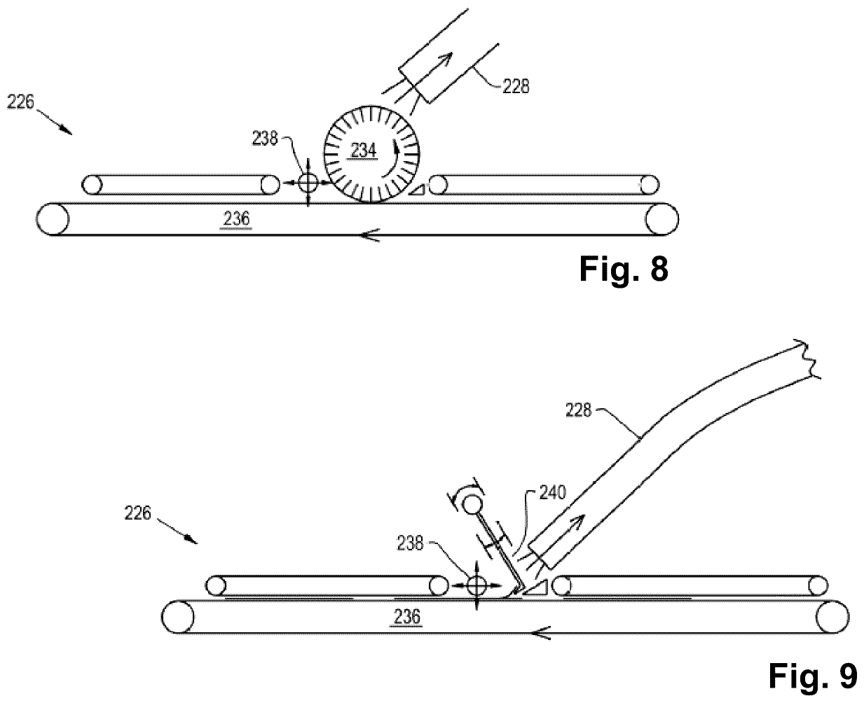

The blanks 100 may be sheet-printed onto sheets as completed one-up images requiring no further or additional cutting or trimming prior to introduction into the feeder unit 202 of the system 200. Alternatively, after printing the printed sheets or web may be cut to yield blanks 100, each being a desired individual final size, one-up, flat product having one or more flat panels. The blanks 100 may be cut from multi-up sheets or from a continuous web on any cutting machine known in the art, such as but not limited to, a standalone rotary, platen, or any other type of guillotine, reciprocal, rotary machine, laser cutting device, or die cutter. As a nonlimiting example, the blanks 100 may be cut from a web using a conventional rotary cutter-type machine 68 prior to being fed into the feeder unit 202 of the system 200. Alternatively, the blanks 100 may be cut from printed sheets directly fed into the feeder unit 202, and subsequently conveyed into a die cutting unit, which as used herein encompasses rotary blanking, die cutting, and/or scoring capable of being performed in any manner. Such a die cutting unit 213 is represented in FIG. 10 at an “entry end location” of the system 200 and is consequently positioned at the entry end of the system 200 containing single up products or larger multiple product up sheets. Bleed and gap trims may be performed to remove waste at the head and foot of each blank 100. Regardless of what type of system is used to produce and cut the blanks 100, the blanks 100 are preferably cut to their overall final shape and size prior to being placed on the entry conveyor (for example, prior to the feeder unit 202 depicted in FIG. 2) and prior to entering the VDP stations 206 and 210 and folding and gluing stations 214, 216, 220, and 230 of the system 200. The blanks 100 may be cut to an overall uniform rectangular shape, though optionally one or more panels of each blank 100 may be longer than other panels, creating what will be referred to as a waste extraction flap 108 (FIGS. 3A-3E, 5A-5B, 6A-6B, and 7A-7B), such that the blank 100 as a whole has an irregular rectangle shape. As will be discussed in reference to FIGS. 3A-3E, the process of defining a card 12 from a portion of the blank 100 (the portion being referred to herein as a card panel 112) results in waste material 110 that surrounds the card 12. Irregular cutting of the blanks 100 to include a waste extraction flap 108 is believed to significantly facilitate the extraction of the waste material 110 when using certain extraction equipment, for example, a cross-fold-drag-hook-and-lift unit 240 (hereinafter, hook and lift mechanism 240) schematically represented in FIG. 9. However, a waste extraction flap 108 may be unnecessary if another type of waste extraction technique is used, for example, a vacuum wheel 234 schematically represented in FIG. 8.

Preparation of the blanks 100 on the system 200 at the entry end location, can be limited to die cutting the cards 12 or most preferably include die cutting an entire blank 100 to final size, die cutting the cards 12, die cutting slits 402, and forming scores for fold lines 400/401 with the die cutting unit 213. Blank cutting may include single chop cuts or double crosscuts for bleed trim and/or gap removal, which may optionally include formation of the waste extraction flap 108, formation of the cards 12 with or without ties 104 to the carrier 14, and/or formation of folding scores along fold lines 106 (FIGS. 3A, 5A, and 6C). If such cutting processes are performed by the system 200, the bleed and gap trim waste formed by the crosscut is extracted immediately after the blank 100 leaves the die cutting unit 213. Once the blanks 100 have been formed, they are conveyed further into the system 200.

When utilizing blanks 100 with the waste extraction flap 108, the blanks 100 are preferably oriented and loaded into the feeder unit 202 with an orientation such that, regardless of a need later in the process to flop or turn over the blanks 100 for VDP, label application, on-serting, or any other additional processes, the waste extraction flap 108 will be at a first or leading edge of the blank 100 in the travel direction of the blanks 100 at a point within the system 200 (e.g. the waste separation station 226) where waste removal is performed to remove material 110 surrounding the cards 12 after the cards 12 have been secured to their carriers 14. As such, it will be apparent to those skilled in the art that consideration must be taken during format layout and printing to determine a correct orientation necessary for proper downstream gluing and plow folding of the blanks 100 so as to result in a desired finished product. In addition, consideration is preferably taken for any downstream processes needed to flop or turn over the blanks 100. As a nonlimiting example, if VDP is to occur on a back side of a portion of the blank 100 which will form a card 12, the blank 100 may be loaded into the feeder unit 202 of the system 200, bottom side up (inside of unfolded carrier panels) or facing upward. This orients the blanks 100 for proper VDP pagination, that is, applied in a downward direction towards to the desired imaged surface of the blanks 100 as opposed to performing VDP from below and therefore in opposition to gravity, though such an approach is also contemplated.

The blanks 100 may be fed into the system 200 by any means known in the art, nonlimiting examples of which include driven by a gravity, friction, or suction vacuum feeder wheel (not shown) associated with the feeder unit 202, which delivers the blanks 100 to an entry conveyor (not shown) and edge guide unit 204. The blanks 100 can be conveyed through the system 200 at speeds typical to the art, for example, with laterally positioned upper and lower motor driven tapes, belts, and/or rollers along the entire length of the system 200 that convey the individual blanks 100 through the various processing stations and units of the system 200.

In some arrangements, promotional products processed by the system 200 may include personalized data applied by simplex and duplex VDP, schematically represented by the two VDP stations 206 and 210 in FIG. 2. Although VDP of trackable or non-trackable data and any other “value added” product format additions may be applied during printing of the sheets or webs from which the blanks 100 are formed, and therefor prior to the blanks 100 entering the system 200, such additions may be performed by the system 200, and in particular prior to the folding stations 214, 216, 220, and 230 of the system 200. This however may add a level of complexity to the process by requiring accurate and intensive “cut and stack” procedures during rotary or platen or any other type/method die cutting of the blanks 100 in order to maintain postal sort sequence throughout the entire finishing process. There may also be additional secondary processes after printing, for example, the addition of foils, mechanical embossing, labels, on-serting, information tracking means such as RFID tags/labels, NFC tags/labels, and/or other information tracking “microchips”, etc. Any of the above additions may also be applied after the sheets or web are converted into blanks 100.

In the example of FIG. 2, personalized data may be applied by the VDP station 206 and the ink applied thereby is preferably immediately dried using any drying process known in the art, such as but not limited to infrared (IR) drying. Thereafter, the blank 100 may be turned over with the turnover unit 208, which may employ any turnover or flopping means known in the art, such as but not limited to a buckle fold/head stop attachment modified, designed, or otherwise adapted to flop or turn over the blanks 100. Turning of the blanks 100 may be accomplished with head to foot, left to right, or right to left methods, as long as the method results in the blank 100 being turned over from top side up to bottom side up in the process. As evident from FIG. 2, turning of the blanks 100 allows for VDP on two sides of the blanks 100 with the VDP station 210. Turning of the blanks 100 may also be used to appropriately orient the blanks 100 for the subsequent folding stations 214, 216, 220, and 230 of the system 200. In addition, turning may be desirable or necessary for other process application equipment employed in the system 200, for example, label applicators, on-serting, information tracking means such as RFID or NFC labels/tags, etc., which may be applied to either side of the blanks 100. Such value-added product format additions may be applied at the optional additions stations 212 represented in FIG. 2.

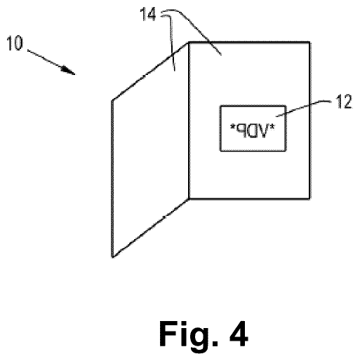

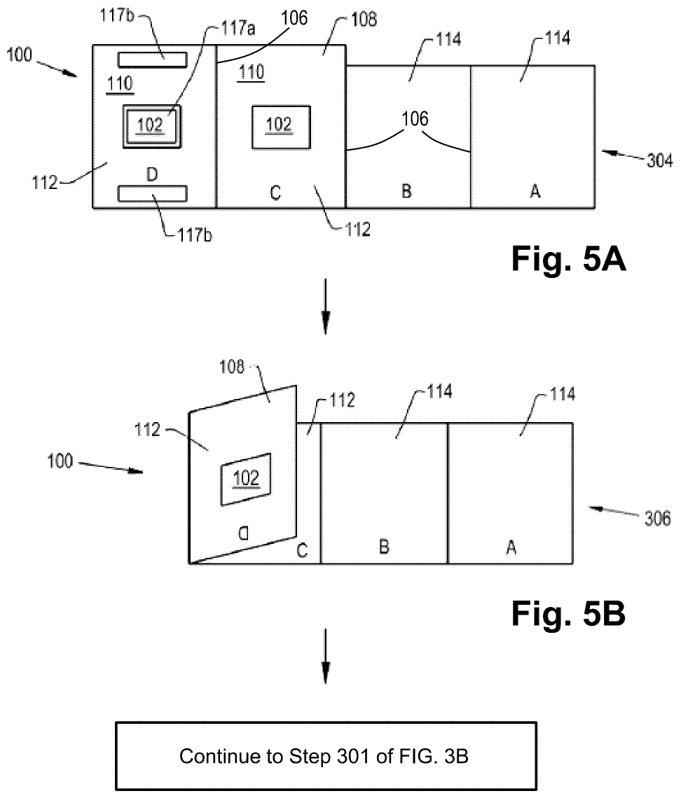

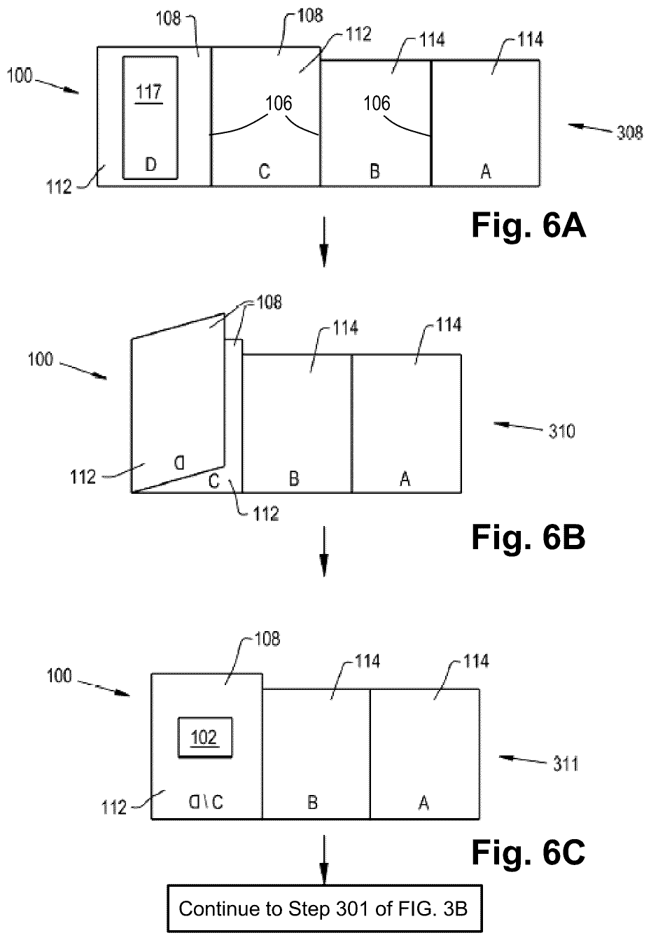

Once all printing, VDP, and application of additions is complete, the blanks 100 undergo folding, gluing, and cutting processes to produce the final promotional product 10. In some configurations, once the blank 100 has been created, a card 12 that is to be applied to the carrier 14 of its promotional product 10 is created from but not initially removed from one or more “card” panels 108 of the blank 100, such that processing of the blank 100 initially results in what will be referred to as a partially cut-out card 102 in the blank 100. Each card panel 112 may be perforated such that its partially cut-out card 102 remains secured to its blank 100 with the aforementioned ties 104 to prevent the partially cut-out cards 102 from falling out of the blank 100 during subsequent folding and gluing processes. However, in other arrangements a partially cut-out card 102 could be partially or solely retained by friction, edge contact, static electricity, etc., without the use of ties 104, and therefore as used herein the term “partially cut-out card(s)” encompasses such possibilities. The blanks 100 are glued and folded in a manner so as to apply the partially cut-out cards 102 in the card panels 112 of the blanks 100 to “carrier” panels of the blanks 100 intended to form the carrier 14 of the promotional product 10. As represented in FIG. 5A, if a card 12 is intended to be multi-ply, the partially cut-out cards 102 may be formed in multiple adjacent card panels 112 and positioned across and opposite from one another so that after gluing and folding of the card panels 112, the partially cut-out cards 102 are aligned (superimposed) and can be glued together to form a single, multi-ply card 12. Alternatively, as represented in FIGS. 6A, 6B, 6C, 7A, and 7B, a multi-ply card 12 can be produced by simultaneously forming partially cut-out cards 102 in multiple card panels 112 after gluing and folding the card panels 112, such that the individual partially cut-out cards 102 are aligned as a result of the cutting, fold line scoring and folding operation. Notably, the cards 12 may be cut to have any shape or size, and may be cut to be partially attached to or completely detached from any number of single- or multi-ply bonded material plies formed of any woven or non-woven paper or other material.

FIGS. 3A-3F are representative of a process for producing a single-ply card 12 applied to a carrier 14. In FIG. 3A, the blank 100 is represented at step 300 as initially including a single card panel 112 “C” and two carrier panels 114 “A” and “B.” The carrier panel B is contiguous with each of the carrier panel A and the card panel C, with corresponding fold lines 106 defined therebetween. Card panel C includes the aforementioned optional waste extraction flap 108 and has been previously die cut to have a partially cut-out card 102. The die cutting operation that forms the partially cut-out card 102 can be performed at any time prior to the condition of the blank 100 represented in FIG. 3B, which shows glue spots 116 as having been applied (for example, by the gluing unit 222 of the first folding station 214) to the carrier panel B contiguous with the card panel C. The glue spots 116 are applied at locations that will be contacted by the partially cut-out card 102 after the card panel C has been folded over and onto carrier panel B along a fold line 106 therebetween, as represented by step 302 of FIG. 3C (for example, performed at the first folding station 214), such that the partially cut-out card 102 contacts the glue spots 116 and is secured therewith to carrier panel B. The remainder of the card panel C surrounding the partially cut-out card 102 does not contact the glue spots 116 and therefore is not attached to the carrier panel B, and as such is capable of being extracted as waste material 110.

FIGS. 3D through 3F represent further steps performed on the blank 100 produced by step 302 of FIG. 3C. The steps represented in FIGS. 3D-3F can be common to the card finishing sequences described in FIGS. 5A-5B and 6A-6C, and therefore can be employed regardless of whether the product 10 is single-ply or multi-ply or the manner in which cards 12 are die cut from the blanks 100. The folding operation of FIG. 3C has created an outer folded edge, referred to as a backbone or spine 119, formed by the combined folded panels B and C. The spine 119 can be removed by slitting the spine 119 (for example, at the slitting station 224 of FIG. 2), as represented in step 320 of FIG. 3D, resulting in a defined edge 118 of the blank 100. In addition, because the remainder of the card panel C surrounding the partially cut-out card 102 was not attached to the carrier panel B, this remainder is detached as a result of the slitting operation and the waste extraction flap 108 can be used in step 322 to remove this remainder from the blank 100 as a waste material 110. Removal of the waste material 110 can be performed at the waste separation station 226 by the waste evacuation system 228 of FIG. 2, for example, as discussed in reference to FIGS. 8 and 9, such that all portions of the card panel C are removed other than the partially cut-out card 102 attached to the carrier panel B. As the waste material 110 of the card panel C is removed, any ties 104 securing the partially cut out card 102 will tear, such that only the resulting card 12 is attached with the glue spots 116 to the carrier panel B. In step 324, a fold line 106 (FIG. 3A) between the carrier panels A and B is folded (for example, at the folding station 230), such that the blank 100 becomes a final promotional product 10 having the single-ply card 12 enclosed between portions of the carrier 14 defined by the carrier panels A and B. FIG. 4 depicts the product 10 oriented and partially unfolded to reveal the card 12 attached to the carrier 14.

FIGS. 5A and 5B represent steps of a nonlimiting example by which a double-ply card 12 can be formed and attached to a carrier 14. As a matter of convenience, the blank is identified in FIGS. 5A and 5B with the reference number 100, though the blank has a physical configuration that is different from the blank 100 of FIG. 3A. In step 304, the blank 100 includes two carrier panels 114 “A” and “B,” and two card panels 112 “C” and “D.” The carrier panel B is contiguous with each of the carrier panel A and the card panel C with corresponding fold lines 106 defined therebetween, and the card panel C is further contiguous with the card panel D with a corresponding fold line 106 therebetween. Each of the card panels C and D includes a waste extraction flap 108 and has been previously die-cut to have a partially cut-out card 102 surrounded by a waste material 110. FIG. 5A shows a glue pattern 117a that has been applied to the partially cut-out card 102 of the card panel D, which is the card panel 112 located farthest from the carrier panels 114. Glue 117b may optionally be applied to the waste material 110 of the panel D, avoiding the die-cut surrounding its partially cut-out card 102. At step 306, the card panel D is folded over and onto the card panel C (for example, at one of the folding stations 214 or 216) so that their partially cut-out cards 102 are aligned (superimposed) and glued together with the glue pattern 117a to eventually form a single double-ply card 12 (equivalent to the card 12 in FIG. 4). At this point in the process, the configuration of the blank 100 resulting from step 306 is generally equivalent to the blank 100 in step 300 of FIG. 3A, in that the combined card panels C and D of step 306 is generally equivalent to the single card panel C of step 300, other than being double-ply instead of single-ply. As such, subsequent processing steps may commence with step 301 of FIG. 3B, starting with application of the glue spots 116, and continuing to produce a final promotional product 10 having the double-ply card 12 enclosed between carrier panels A and B. Notably, because the waste material 110 of the card panels C and D are not bonded to each other with the glue 117b as a result of the folding step 306, the waste material 110 can be simultaneously removed (step 322) following removal of the spine 119 (step 320) formed by panels B, C, and D, such that all portions of the card panels C and D are removed other than the bonded partially cut-out cards 102. As the waste materials 110 are removed, any ties 104 securing the partially cut-out cards 102 will tear, leaving the double-ply card 12 on the carrier panel B. Following step 324 (FIG. 3F), the resulting product will again have the overall appearance of the product 10 depicted in FIG. 4.

The order and number of such card cutting, folding, and gluing processes will be dependent on the desired final product. In the embodiments of FIGS. 3A-3F and 5A-5B, die cuts to form the partially cut-out cards 102 are performed prior to folding, and can be performed prior to the blank 100 entering the system 200 of FIG. 2 or as one of the initial process steps performed within the system 200. Alternatively, as represented by the embodiments of FIGS. 6A-6C and 7A-7B, the partially cut-out cards 102 may be formed in the system 200 following a gluing and folding operation, for example, with the use of the one or more optional mid-line die cutters 218 located at a “midline location” of the system 200, and then followed by one or more additional folding and/or gluing steps.

FIGS. 6A-6C represent a nonlimiting example of a process for producing a double-ply card 12 similar to that produced by the process of FIGS. 5A-5C, modified to form the partially cut-out cards 102 after a gluing step. In FIG. 6A, the blank 100 initially includes two carrier panels 114 “A” and “B” and two card panels 112 “C” and “D.” In contrast to FIG. 5A, which depicts a similar four-panel blank 100, the partially cut-out cards 102 have not been pre-die cut in the card panels C and D during the formation of the blank 100. In step 308, a nonlimiting glue pattern 117 is applied to the card panel D to the extent necessary to bond the portion(s) of the card panels C and D in which a partially cut-out card 102 is to be formed. In step 310, card panel D (again, the card panel 112 located farthest from the carrier panels 114) is folded over and onto the card panel C (for example, at one of the folding stations 214 or 216) such that the panels C and D contact and are optionally secured to one another by the glue pattern 117. In step 311, the partially cut-out card 102 is formed (for example, with the use of the one or more optional mid-line die cutters 218) by die-cutting the combined panels C and D, such that the partially cut-out card 102 is double-ply and simultaneously formed in the panels C and D. At this point in the process, the blank 100 produced by step 311 is generally equivalent to the blank 100 resulting from step 300 of FIG. 3A, in that the combined panels C and D of step 311 are generally equivalent to the panel C seen in FIG. 3A except for being double-ply instead of single-ply. As such, subsequent processing steps may commence with step 301 of FIG. 3B, starting with application of the glue spots 116, and continuing to produce a final promotional product 10 having the double-ply card 12 enclosed between carrier panels A and B. As with the embodiment of FIGS. 5A-5B, because the waste materials 110 of the card panels C and D are optionally bonded to each other by the glue pattern 117 as a result of the folding step 310, the waste materials 110 can be simultaneously removed (step 322 of FIG. 3E) following removal of the spine 119 (step 320 of FIG. 3D) formed by the panels B, C, and D, such that all portions of the card panels C and D are removed other than the double-ply partially cut-out card 102. As the waste materials 110 are removed, any ties 104 securing the partially cut-out card 102 will tear, leaving the double-ply card 12 on the carrier panel B. Following step 324 (FIG. 3F), the resulting product will again have the overall appearance of the product 10 depicted in FIG. 4.

The cards 12 and carriers 14 may be produced to have more plies by simply adding additional panels to the blank 100 and then gluing and folding the panels to increase the final thickness of the card 12 and/or carrier 14. Folding stations may be added prior to the slitting station 224 to more easily process multi-ply promotional products of three plies or more. As a nonlimiting example, FIGS. 7A and 7B represent steps in a process for producing a promotional product 10 having a triple-ply card 12. As represented, the blank 100 initially includes two carrier panels 114 “A” and “B,” and three card panels 112 “C,” “D,” and “E.” As with the blank 100 of FIGS. 3A and 6A, the carrier panel B is contiguous with each of the carrier panel A and the card panel C with corresponding fold lines 106 defined therebetween, and the card panel C is further contiguous with the card panel D with a corresponding fold line 106 therebetween. Additionally, the card panel D is also contiguous with the card panel E with a corresponding fold line 106 therebetween. In step 316, a glue pattern 117 is applied to the card panel E to the extent necessary to bond the portion(s) of the card panels D and E in which two aligned partially cut-out cards 102 are to be formed. In step 318 of FIG. 7B, the card panel E (again, the card panel 112 located farthest from the carrier panels 114) is folded over and onto the card panel D (for example, at one of the folding stations 214 or 216) such that the panels D and E contact and are secured to one another by the glue pattern 117. At this point in the process, except for the absence of the glue pattern 117 the blank 100 produced by step 318 is generally equivalent to the blank 100 shown in FIG. 6A, in that the combined panels D and E of step 318 is generally equivalent to the panel D seen in FIG. 6A except for being double-ply instead of single-ply. As such, subsequent processing steps may commence with step 308 of FIG. 6A, starting with application of the glue pattern 117 to the combined panels D and E, and continuing through steps 310 and 311 of FIGS. 6B and 6C and then continuing further on through the steps represented in FIGS. 3B through 3F to produce a final promotional product 10 having a triple-ply card 12 (formed by the card panels C, D and E) enclosed between the carrier panels A and B. The type of glue and fold sequence performed to bond the combined panels D and E with the third card panel C is commonly referred to a “roll fold” sequence with a unique function being that each panel is fully or partially glued together to create multiple plies. As with the prior embodiments of FIGS. 5A-5B and 6A-6C, because the waste materials 110 of the card panels C, D and E are bonded to each other as a result of the folding steps 318 and 310, the waste materials 110 are bonded to each other and therefore can be simultaneously removed (step 322 of FIG. 3E) following removal of the spine 119 (step 320 of FIG. 3D) formed by the panels B, C, D, and E, such that all portions of the card panels C, D and E are removed other than the triple-ply partially cut-out card 102. As the waste materials 110 are removed, any ties 104 securing the partially cut-out card 102 will tear, leaving the triple-ply card 12 on the carrier panel B. Following step 324 (FIG. 3F), the resulting product will again have the overall appearance of the product 10 depicted in FIG. 4.

In view of the foregoing, single and multi-ply partially cut-out cards 102 can be formed in the blanks 100 prior to entering the system 200 (FIGS. 3A and 5A) by die cutting the blanks 100 or an entire multi-up press sheet or web from which the blanks 100 are made to produce single and multi-ply cards 12, whereas multi-ply partially cut-out cards 102 formed in the blanks 100 within the system 200 (FIG. 6C) may alternatively be die cut with the use of the one or more optional mid-line die cutters 218 to produce multi-ply cards 12. The mid-line die cutter(s) 218 may be used to die cut single-ply partially cut-out cards 102 while the panels of the blanks 100 are flat, or die cut multi-ply partially cut-out cards 102 after gluing and folding panels of the blanks 100 together into multi-ply thicknesses.

The optional mid-line die cutter 218 may be any type of die cutter known in the art, such as but not limited to rotary and platen die cutters, or laser, or any other type/method capable of making a complete cut or kiss-cut, the latter referring to a technique in which the die cutter cuts to a specific depth through a substrate (e.g., one or more card panels 112) while leaving an underlying substrate (e.g., carrier panel 114) uncut. The mid-line die cutter 218 may have several locations within the system 200 and include special modifications such as a sidelay adjustable die-cutting cylinder head and specialty transport sections designed to convey under control individual blanks 100 through the rotary cylinder sections. The mid-line die cutter(s) 218 in the form of a rotary-style die cutter may be specifically designed with any circumference to match any product length with repeat, or non-repeat matching mid-line die cutter designs may employ a motor drive system that operates independently of the main drive of the system 200 and may further utilize an “electronic cam profile” cutting cylinder drive or other nonlimiting electronic and/or mechanical technology. As a nonlimiting example, changeable die cutting cassettes, cylinders or sleeve style designs can be employed to allow changes in the circumferential size of a rotary-style die cutter to meet the conveyance of the blanks 100 by promoting the timing and positional accuracy of the blanks with respect to desired die cut locations on the blanks 100. It is foreseeable that other control and registration techniques could be used to synchronize the die cutter(s) 218 with the blanks 100 as the blanks 100 pass through the die cutter(s) 218 during die cutting of the card(s) 12 or the partially cut-out cards 102 from which they are formed. In the case of a rotary-style die cutter, an independent motor drive system may include separated drive motors for a die cutting cylinder and opposing anvil cylinder, and/or for a conveyance drive carrying the blanks 100 through the die cutter 218. Other types of die cutters commonly used in rotary die cutters include commercially available flexible magnetic die using a magnetic mount die cylinder or a solid-type die screw lockdown style made normally of steel or composite materials. Mid-line die cutters 218 for use in the system 200 may also be used in multiples to separate x and y axis cutting, and/or portable and moveable to allow the cards 12 to be die cut to any shape or thickness.

In some embodiments, the mid-line die cutter(s) 218 form the partially cut-out cards 102 immediately prior to the gluing and folding operation by which a partially cut-out card 102 formed by one or more card panels 112 is semi-permanently fixed with one or more glue spots 116 to the one of the carrier panels 114 prior to removal of the waste material(s) 110. As apparent from the forgoing discussion of FIGS. 3A-3F, FIGS. 5A-5B, 6A-6C, and 7A-7B, such a process may involve any number of card panel gluing and folding processes prior to the die cutting operation, and the die cutting operation may be made through any number of previously folded card panels 112 (plies).

In other embodiments, the partially cut-out cards 102 may be formed by the optional mid-line die cutter 218 after all folding and gluing operations have been performed on the panels 112 and 114 of the blank 100. In such situations, all card panels 112 to be glued and folded, including the final fold onto the glue spots 116 of the card panel 112 or panels 112 bearing what will be the partially cut-out cards 102, occurs before any die cutting operation takes place. The cards 12 are only thereafter die cut from the card panels 112 using the mid-line die cutter 218 set to a specific depth and pressure adjustment to cut through only the card panels 112 while leaving the underlying carrier panel 114 uncut. Such a kiss-cutting technique eliminates the need to perforate die cut the card panels 112 immediately prior to the final fold-over of the card panels 112 at the score line 106 onto glue spots 116, and instead the cards 12 are completely separated from the card panels 112 with a single cut after all folding and gluing operations have taken place.

The use of scores or another technique, such as cut scores or perforations formed by channel, crush, or other methods, is believed to be advantageous to the folding processes within the system 200. When single-ply cards are produced (e.g., FIGS. 3A-3F), high accuracy matching of folding panels may not be required and therefore scoring may not be necessary. When multi-ply cards are produced (e.g., FIG. 5A-5B, 6A-6C, or 7A-7B), folding accuracy is critical to ensure that the partially cut-out cards 102 and/or card panels 112 are located in the desired lateral position, especially when multiple partially cut-out cards 102 are to be combined to form a multi-ply card 12 (e.g., FIGS. 5A-5B). In such situations, initial die placement and scoring position accuracy along fold lines 106 directly between the card panels 112 may be of utmost importance and preferably executed at time and place of card die cutting. Notably, if the blanks 100 were not previously scored during the blank formation process, it is entirely possible and viable to score the blanks 100 with an appropriate scoring unit included in the system 200 using any process known in the art. As such, scores may be formed within fold lines 106 on an entire multi up press sheet, web, or blank 100 at any time or any place while the sheet, web, or blank 100 is flat and yet to be glued and/or folded. Although not required for single-ply card formats, scoring, cut scoring or perforation is typically preferred to provide overall general product quality when folding heavy gauge paper stock.

Folding operations performed by any one or more of the folding stations 214, 216, 220, and 230 of the system 200 are preferably performed with a plow fold blade designed “down” and the folding panel being folded upward and over. However, the system 200 can be configured for “up” fold orientations, i.e., opposite the prior description, loading and format procedures remain the same and may eliminate blank flopping or turnover. Regardless, methods of production for both “up” and “down” fold orientation may be implemented.

Single- and multi-ply cards 12 of promotional products 10 produced with the system 200 will typically be glued to one of the carrier panels 114 during the final folding operation (e.g., at folding station 230) with one or more glue spots 116 or other suitable pattern of a hot melt glue using any gluing system known in the art, such as but not limited to a rotary, mechanical, pattern programmable electronic slot head, extrusion, spray, or other for hot melt or cold glue station. While shown in FIG. 3B as applied to one of the carrier panels 114, the glue spots 116 may be applied to the side of the partially cut-out card 102 facing the carrier panel 114. The glue spots 116 are preferably sequenced and timed to be precisely applied to the carrier panel 114 in one or more locations so that the partially cut-out card 102 will contact the glue spots 116 upon the final folding operation In some embodiments, timing of the cards 12 and the carriers 14 always remains constant and never out of time (as possible with conventional printing, card placement, and finishing techniques) due to the inherent nature of plow folding of the card panels 112 over onto the carrier panels 114 with an intact backbone or spine (at the fold line 106 therebetween) remaining in place during folding. This process, along with the use of identical and contiguous paper stock blank for cards and carriers, also ensures both circumferential and lateral registration of fine graphics content, color match, and “crossover image” match between the cards 12 and the carriers 14.

As described previously, after completion of the final folding of the card panel 112, waste materials 110 remain connected to the remainder of the blank 100 with previously folded backbones or spines 119, which physically connect the card panels 112 to the carrier panels 114, and, if present, the ties 104 between the waste materials 110 and the partially cut-out cards 102 that were previously glued to the carrier panels 114. As represented in FIG. 3D, such a spine 119 created from folded card panels 112 is located at an outer edge of the blank 100, and may be removed by using the slitting section 224 to cut the spine 119 from the remainder of the card panels 112. The slitting section 224 may be, but is not limited to, a crush-type rotary slitter wheel which crush/pressure slits against a rotary lower hardened anvil roll surface, or a shear-type rotary slitter which face slits against a side or lower rotating hardened anvil cylinder. Once the spine 119 has been cut, the waste evacuation system 228 may be used to remove the waste materials comprising the spine 119.

As previously noted, the optional waste extraction flap 108 provides an additional region of material (e.g., paper) at what becomes the leading edge of the blank 100 as it reaches the waste separation station 226 in the system 200. Because the waste extraction flap 108 extends or protrudes beyond the desired finished length of the promotional product 10, the flap 108 is the first portion of the blank 100 to encounter the waste separation station 226, and therefore can be an effective aid in removal of the waste material 110 from the blank 100. The waste separation station 226 may remove the waste material 110 by any means known in the art and rely on any suitable electrical-, mechanical-, pneumatic-, and/or vacuum-based technique. A nonlimiting example of a waste separation station 226 adapted to employ the waste extraction flap 108 to remove the waste material 110 from a blank 100 is represented in FIG. 9. The waste separation station 226 is represented as including the aforementioned hook and lift mechanism 240 similar to those typically used in to cross-fold scored carton ends (perpendicular to product travel direction) into the carton center, that is, a folding carton lock bottom In some embodiments, the hook and lift mechanism 240 is configured to lift and separate the waste materials 110 of card panels 112 by lifting a leading edge of the blank 100, for example, the waste extraction flap 108, for removal by the waste evacuation system 228. As each waste material 110 is removed, its corresponding card 12 remains adhered to its carrier panel 114. As previously noted, a blank 100 equipped with a waste extraction flap 108 is preferably fed into the system 200 such that, after any flopping of the blank 100, the waste extraction flap 108 defines the leading edge of the blank 100 in the direction of travel when the blank 100 reaches the waste evacuation system 228. As such, the hook and lift mechanism 240 is able to first interact with the waste extraction flap 108 to remove the waste material 110 without disturbing the carrier panels 114 or the cards 12 secured thereto. The hook and lift mechanism 240 may be, for example, a timed physical function resulting from the blank 100 triggering an optic or physical sensor to activate a mechanical hook function, or a spring-loaded return hook mechanism which drags the blanks 100 and snags the leading edge of the waste extraction flap 108 as the blanks 100 are conveyed by tapes, rollers, vacuum table belts, or any other drive methods known in the art.

Alternatively, if the waste extraction flap 108 is not used, any combination of methods known in the art may be used to remove the waste material 110. FIG. 8 represents a nonlimiting example comprising one or more vacuum wheels 234 and one or more vacuum tables 236, for example, a conveyor with a perforated belt through which a vacuum is drawn. In such a configuration, the vacuum table 236 may hold down the carrier panels 114 during removal and air suction extraction of the waste material 110 by the suction wheels 234 and waste evacuation system 228.

Both FIGS. 8 and 9 further represent the waste separation station 226 as including optional pinching or pressing rollers 238 configured to provide a holding pressure to the partially cut-out cards 102 attached to the carrier panels 114 as the waste material 110 are removed. The pinching/pressing rollers 238 may be adjustable in multiple axes, including a vertical direction (up-down) relative to the vacuum table 236 in order to apply pressure to the partially cut-out cards 102 and the carrier panels 114, as well as in a horizontal direction (forward-backward) relative to the direction of travel of the blanks 100.

The waste separation station 226 in some configurations could be limited to using only the vacuum table 236 and/or adjustable guides or fingers (not shown) to hold the carrier panels 114 down while the waste material 110 are removed. Other known nonlimiting methods include cam style rotary, reciprocating type, and/or pivot gates, all of which may function by means of a motion-phased gearbox/belt/pulley or motorized electronic or pneumatic activation devices cued and activated from any type of optic, electronic, or mechanical position sensors through PLC or relay logic activation for all typical methods known for such timing functions.

After removal of the waste material 110, the products 10 will typically comprise one or more cards 12 secured to one of the carrier panels 114. Any remaining stations of the system 200 may be configured to finish and convert the remainder of the blank 100 from the flat carrier panels 114 into the final promotional product 10. Nonlimiting examples include folding the carrier panels 114 to produce a multi-page promotional product, spot/line gluing or running perforation to enclose the product 10 to meet postal regulations, additional die cutting processes for features such as windows or sculpted edges, on-serting or label additions, and/or running or pattern perforations to enclose the entire promotional product 10 into a “zip” opening format. For example, step 324 in FIG. 3F represents the carrier panels 114 of step 322 (FIG. 3E) as being folded along a scored fold line 106 between the panels 114 to form a four-page promotional product 10. Other foreseeable formats include any conceivable number of lateral or horizontal folds or pagination formats including cross-folding of leading and trailing edge flaps of the blank 100 to create an “iron cross” or an all-sides folding around the card 12.

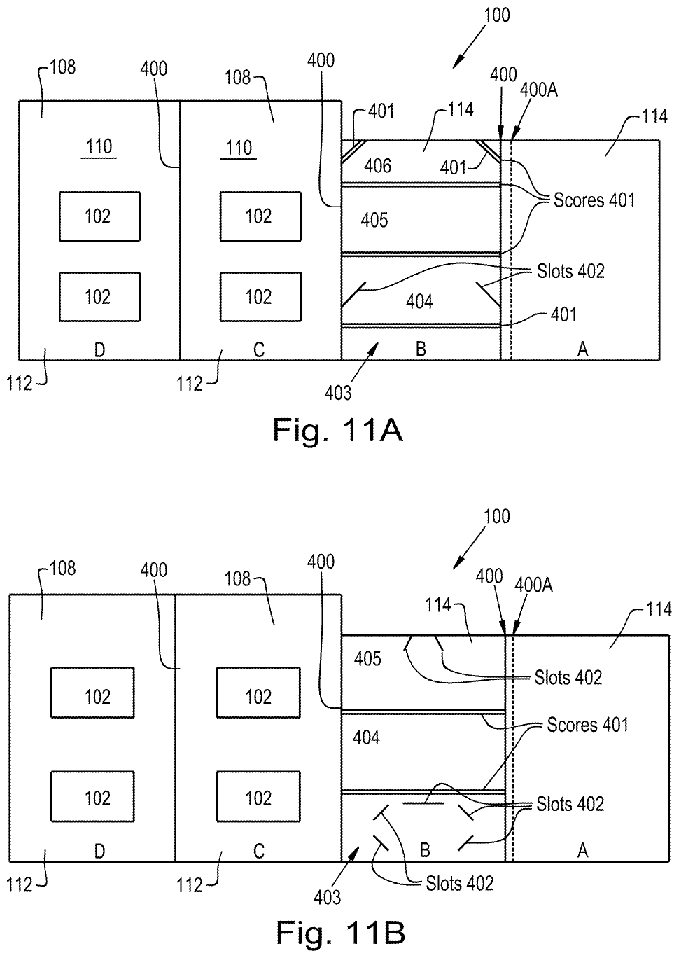

FIGS. 3A-3E and 5A-7B represent nonlimiting examples of processing steps that may be employed to produce gift cards 12 along with one or more panels 114A and 114B from a single contiguous blank 100 in accordance with aspects of the present invention. FIG. 11A and FIG. 11B show two nonlimiting examples of flat, unfolded blanks including a schematic panel layout including nonlimiting die cut cards 12 within card panels 112c and 112d, including waste material panels 110c and 110d, an informational panel 114A, and a carrier panel 114B. The carrier panel 114B is further referred to as an enveloping carrier panel 114B. FIG. 10 schematically represents a “folder/gluer” system 200 adapted for use in such processes, and unless otherwise indicated references to the system 200 and its components hereinafter are to the system 200 of FIG. 10.

As illustrated in FIG. 10, the system 200 is substantially similar to the folder gluer system 200 illustrated in FIG. 2, but with the addition of the optional die cutting unit 213 at the “entry end location” identified in FIG. 10. The system 200 is represented in FIG. 10 as including a feeder station that may comprise a feeder unit 202 and an edge guide unit 204, followed by the optional die cutting unit 213 at the entry end location, optional VDP stations 206 and 210 that apply individualized data to the blanks 100, an optional turnover unit 208, one or more optional “additions” stations 212 for non-limiting product embellishments such as on-serting tags, stickers, NFC, RFID or the like, multiple folding stations 214, 216, 220, and 230 (each of which may include a folding/gluing unit 222), one or more optional mid-line die cutters 218 at a “midline location,” a “slitting” station 224, a waste separation station 226 where waste separation occurs, a waste evacuation system 228, and a “postal-ready” station 232. In general, as represented the system 200 is configured to convey, blank, die cut, score, VDP image, flip, on-sert, fold, glue, die cut, slit, waste extract, and shingle/stack the blanks 100 in order to produce final products, such as but not limited to the promotional (direct mail) products 10 of FIG. 1, as well as nonlimiting examples of promotional products represented in FIGS. 11A through 17B.

Similar to the system in FIG. 2, the system 200 of FIG. 10 could include fewer or additional stations, units, etc. Furthermore, there are many variations in how and in what sequence certain operations may be performed, and various hybrid executions are foreseeable, as described previously.

Promotional products in accordance with aspects of the invention may be initially preprinted by applying images to a sheet or web using any printing means known or developed in the art, such as but not limited to a fixed repeat rotary sheet fed offset, web fed offset, digital inkjet, digital toner, flexographic, rotogravure or other type of printing press, as well as hybrids of any combination thereof. Widely used methods include sheet-fed and web-fed processes in which the feedstock has been digitally preprinted by VDP. Printed sheets may have an approximate finished size of typically 1, 2, 3, 4 or 5 up/around, but can be any multiple of repeat images that fit into a traditional rotary press or rotary sheet repeat circumference. Preprinted sheets or a printed web may comprise completely variable images printed from a non-cylindrical digital inkjet, digital toner, laser, or any other spray-on ink transfer printing method and specifically delivered sheeted as individual sheets into a receding pile, conveyor table, or other delivery. Printing may include one or both sides of a sheet or web and can include any ink color additions or sequence, UV cured coatings, aqueous coatings in any image pattern or area, or other application known in the art.

A particular but nonlimiting example of the above is to position the system 200 immediately and directly following a printing press, which may utilize any print engine technology available and produce from sheet to sheet or roll to sheet containing one or more blanks to be individually blanked upon entry to the system 200 or printed and sheeted individually at final blank size. Preprinted blanks 100 may have any suitable format size for producing the intended gift card(s) 12 and enveloping carrier panel 114B. The cutting operation that produces the blank 100 may take place at the exit of the press or may take place at the entry of the system 200 or anywhere thereafter prior to a folding operation and therefore within a continuous “inline” blank conveyance and operation. As such, the system 200 is capable of being combined as “inline” or “offline/nearline” with a wide variety of printing presses and systems.

As a particular but nonlimiting alternative to the above, images can be applied to printed or non-preprinted blanks 100 after they have entered the system 200. Any suitable printing means can be employed to perform any portion or the entirety of the printing operation(s) performed to produce a product.

In particular embodiments capable of producing the nonlimiting examples of promotional products represented in FIGS. 11A through 17B, portions of a sheet or web that will later form the cards 12 and enveloping carrier panels 114B of promotional products are preferably printed side-by-side and laterally across the width of the sheet or web, such that blanks formed therefrom, which in the nonlimiting examples illustrated in the drawings are represented by the aforementioned individual integral blanks 100, may later be folded to produce the finished promotional products. Preferably, VDP is performed prior to gluing and folding the blanks 100, but may be performed at any time with or during initial printing operations and/or after a blank 100 has been folded within the system 200. Other additions to the blanks 100 may be added at any time preceding or within the system 200. Such additions may include, but are not limited to, foiling, embossing, UV-cured protective or enhancement coatings, aqueous coatings, labels, NFC, RFID tags, and/or unique I.D. VDP embedded within card plies or surface mounted onto a card, or using specialized inks.

The blanks 100 may be sheet-printed onto sheets as completed one-up images requiring no further or additional cutting or trimming prior to introduction into the feeder unit 202 of the system 200. Alternatively, after printing the printed sheets or web may be cut to yield blanks 100, each being a desired individual final size, one-up, flat product having one or more flat panels. The blanks 100 may be cut from multi-up sheets or from a continuous web on any cutting machine known in the art, such as but not limited to, a standalone rotary, platen, or any other type of guillotine, reciprocal, rotary, or laser cutting machine, device, or die cutter. As a nonlimiting example, the blanks 100 may be cut from a web using the rotary cutter-type machine prior to being fed into the feeder unit 202 of the system 200. Alternatively, the blanks 100 may be cut from printed sheets directly fed into the feeder unit 202, and subsequently into the die cutting unit 213 positioned at the entry end location of the system 200 as multiple up/around sheets. Bleed and gap trims may be performed to remove waste at the head and foot and side edges of each blank 100.

A preferred method to create individual final trimmed blanks from larger preprinted, single or multiple up sheets is by the die cutting unit 213 placed within the system 200 near the entry end location of the system 200 following optional functions such as the VDP stations 206 and 210, the turnover unit 208, any optional additions station 212 for applying product embellishments or special applications or labels, tags RFID, etc., that may take place to a full uncut sheet or blank ahead of die cutting the blank to final size or die cutting cards and ahead of the gluing unit 222. At the time of final size blank creation from single size blank or multi up individual blanks contained on larger sheets, it is preferred that at the time of individual blank creation, all die cutting is done to create final bleed removals, irregular blank shaping, die cutting of the gift card 12, fold scoring (e.g., cut or scored) lines 401 of weakness and slits 402. All blanking related trim waste removal takes place immediately following the die cutting unit 213 near the entry end location of system 200 and prior to the gluing and folding stations 222, 214, 216, and downstream of waste extraction 220 and 230. The blanks 100 may be cut to an overall uniform rectangular shape, though optionally one or more panels of each blank 100 may be longer than other panels, creating what will be referred to as a waste extraction flap 108 (FIGS. 11A and 11B), such that the blank 100 as a whole has an irregular rectangle shape. As will be discussed in reference to FIGS. 11A-14F, the process of defining a card 12 from a portion of the blank 100 (the portion being referred to herein as a card panel 112) results in waste material 110 that surrounds the partially cut-out card 102. Irregular cutting of the blanks 100 to include a waste extraction flap 108 is believed to significantly facilitate the extraction of the waste material 110 when using certain extraction equipment, for example, a cross-fold-drag-hook-and-lift unit. However, a waste extraction flap 108 may be unnecessary if another type of waste extraction technique is used.

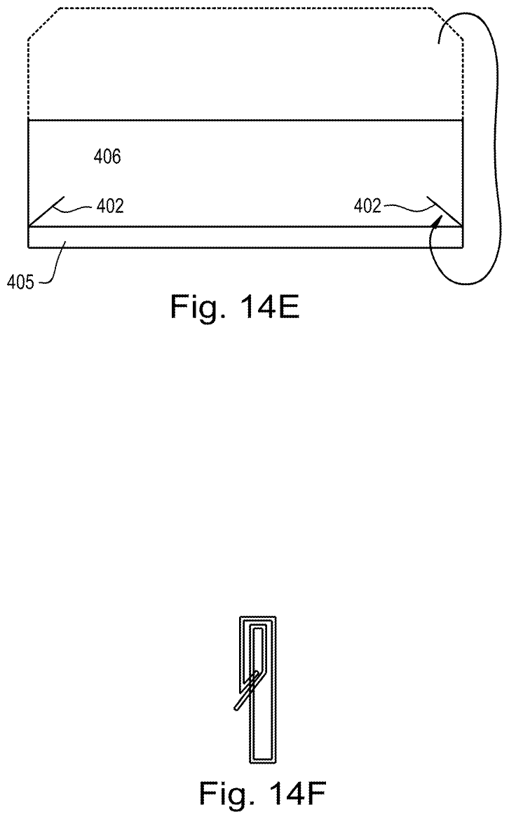

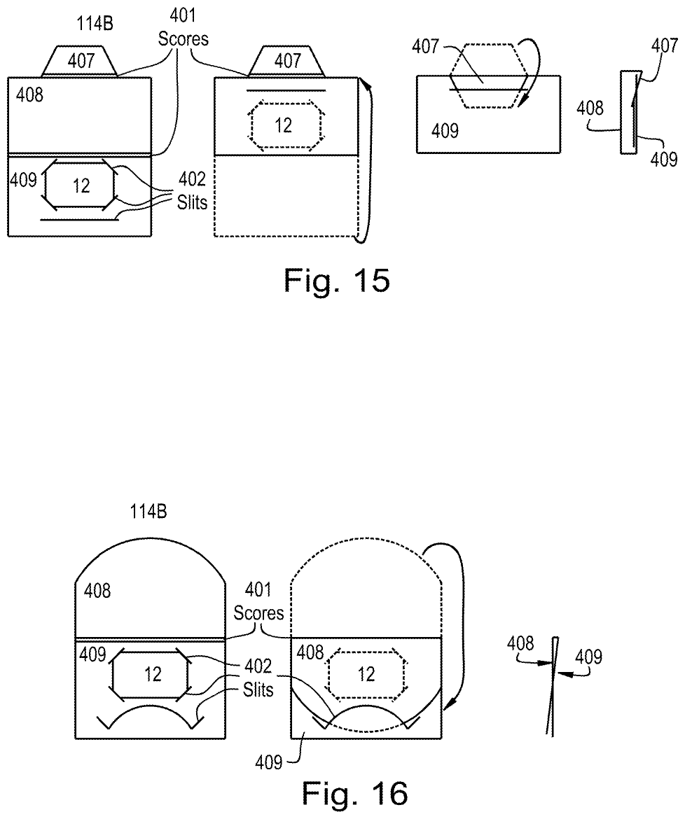

For producing the nonlimiting examples of promotional products represented in FIGS. 11A through 17B, at the time of blanking an irregular shape may optionally be produced to facilitate a latch tab or curved edge on an enveloping carrier panel 114B as exhibited in non-limiting examples for a panel 407 of FIG. 15 and a panel 408 of FIG. 16. All surrounding waste removed for irregular tab or latch creation will be expelled during blanking-related trim waste removal taking place immediately following the die cutting unit 213 near the entry end location of the system 200, prior to the gluing and folding stations 222, 214, 216, and downstream of the waste separation station 226 at the gluing and folding stations 222, 220 and 230.

Preparation of the blanks 100 on the system 200 can be limited to die cutting the cards 12 or as described previously, to include die cutting the entire blank 100 to final size, die cutting the cards 12, and die cutting slits 402 and forming scores for fold lines 400/401 together in the die cutting unit 213 at the entry end location. Once the blanks 100 have been formed, they are conveyed further into the system 200. FIGS. 11A and 11B, 15, and 16 further represent nonlimiting layout patterns for the slits 402 and fold lines 401 on a detachable panel 114B whereby any configuration of folding and scores in an enveloping carrier panel 114B are included to create examples shown in enveloping panels 403, 404, 405, 406, 407, 408, and 409 to assist with manual folding and formation of enveloping carrier panels 114B derived from the contiguous blank 100 furthermore including one or more informational panels 114A.

When utilizing blanks 100 with the waste extraction flap 108, the blanks 100 are preferably oriented and loaded into the feeder unit 202 with an orientation such that, regardless of a need later in the process to flop or turn over the blanks 100 for protective or enhancement coatings, VDP, label application, unique I.D. and dynamic QR codes, NFC and/or RFID devices, magnetic strips, on-serting, or any other additional processes, the waste extraction flap 108 will be at a first or leading edge of the blank 100 in the travel direction of the blanks 100 at a point within the system 200 (e.g. the waste separation station 226) where waste removal is performed to remove material 110 surrounding the cards 102 after the cards 102 have been secured to their enveloping carrier panels 114B. As such, it will be apparent to those skilled in the art that consideration must be taken during format layout and printing to determine a correct orientation necessary for proper downstream gluing and plow folding of the blanks 100 so as to result in a desired finished product. In addition, consideration is preferably taken for any optional downstream processes that may be needed to flop or turn over the blanks 100. As a nonlimiting example, if VDP is to occur on a back side of a portion of the blank 100 which will form a card 12, the blank 100 may be loaded into the feeder unit 202 of the system 200, bottom side up (inside of unfolded carrier panels) or facing upward. This orients the blanks 100 for proper VDP pagination, that is, applied in a downward direction towards to the desired imaged surface of the blanks 100 as opposed to performing VDP from below and therefore in opposition to gravity, though such an approach is also within the scope of the invention.

The blanks 100 or entire multi-up nonblanked sheets may be fed into the system 200 by any means known in the art, nonlimiting examples of which include driven by a gravity, friction, or suction vacuum feeder wheel (not shown) associated with the feeder unit 202, which delivers the blanks 100 to an entry conveyor (not shown) and edge guide unit 204. After blanking to final size, the blanks 100 can be conveyed through the system 200 at speeds typical to the art, for example, with laterally positioned upper and lower motor-driven tapes, belts, and/or rollers along the entire length of the system 200 that convey the individual blanks 100 through the various processing stations and units of the system 200. These driving methods are well known in the art and therefore will not be explained further herein.

In preferred embodiments, all printing including VDP additions is completed before the blanks 100 enter the system 200. However, it is also within the scope of the invention that promotional products processed by the system 200 may include personalized data that is applied by simplex and duplex VDP within the system 200, schematically represented by two VDP stations 206 and 210 in FIG. 10. Although VDP of trackable or non-trackable data and any other “value added” product format additions may be applied during printing of the sheets or webs from which the blanks 100 are formed, and therefor prior to the blanks 100 entering the system 200, such additions may be performed by the system 200, and in particular prior to the folding stations 214, 216, 220, and 230 of the system 200. This however may add a level of complexity to the process by requiring accurate and intensive “cut and stack” procedures during rotary or platen or any other type/method die cutting of the blanks 100 in order to maintain postal sort sequence throughout the entire finishing process. There may also be additional secondary processes after printing, for example, the addition of protective or enhancement coatings, foils, mechanical embossing, labels, on-serting, information tracking means such as RFID tags/labels, NFC tags/labels, and/or other information tracking “microchips”, magnetic strips, unique and dynamic QR codes, barcodes, etc. Any of the above additions may also be applied after the sheets or web are converted into blanks 100.

In the system 200 of FIG. 10, personalized data may be applied by the VDP station 206, and the ink applied thereby is preferably immediately dried using any drying process known in the art, such as but not limited to infrared (IR) drying. Thereafter, the blank 100 may be turned over with the turnover unit 208, which may employ any turnover or flopping means known in the art, such as but not limited to a buckle fold/head stop attachment modified, designed, or otherwise adapted to flop or turn over the blanks 100. Turning of the blanks 100 may be accomplished with head to foot, left to right, or right to left methods, as long as the method results in the blank 100 being turned over from top side up to bottom side up in the process. As evident from FIG. 10, turning of the blanks 100 allows for VDP on two sides of the blanks 100 with the VDP station 210. Turning of the blanks 100 may also be used to appropriately orient the blanks 100 for the subsequent folding stations 214, 216, 220, and 230 of the system 200. In addition, turning may be desirable or necessary for other process application equipment employed in the system 200, for example, label applicators, on-serting, information tracking means such as RFID or NFC labels/tags, etc., which may be applied to either side of the blanks 100. Such value-added product format additions may be applied at the optional additions station 212 represented in FIG. 10.

Once all printing, VDP, and application of additions is complete, the blanks 100 undergo folding, gluing, and cutting processes to produce the final promotional product, such as those produced from or represented in FIGS. 11A through 17B. According to a preferred aspect of the invention, once the blank 100 has been created, a card 12 that is to be applied to the (preferably but not necessarily enveloping) carrier panel 114B or of its promotional product 10 is created from but not initially removed from one or more “card” panels 112 of the blank 100, such that processing of the blank 100 initially results in a partially cut-out card 102 in the blank 100. Each card panel 112C and 112D may be perforated such that its partially cut-out card 102 remains secured to its blank 100 with the aforementioned ties 104 to prevent the partially cut-out cards 102 from falling out of the blank 100 during subsequent folding and gluing processes. However, it is also within the scope of the invention that a partially cut-out card 102 could be partially or solely retained by friction, edge contact, static electricity, etc., without the use of ties 104, and therefore as used herein the term “partially cut-out card(s)” encompasses such possibilities. The blanks 100 are glued and folded in a manner so as to apply the partially cut-out cards 102 in card panels 112C and 112D of the blanks 100 to carrier panels of the blanks 100 intended to form the enveloping carrier panel 114B of the promotional product 10. If a card 12 is intended to be multi-ply, the partially cut-out cards 102 may be formed in multiple adjacent card panels 112C and 112D and positioned across and opposite from one another so that after gluing and folding of the card panels 112, the partially cut-out cards 102 are aligned (superimposed) and can be glued together to form a single, multi-ply card 12.

FIG. 11A represents a nonlimiting embodiment of the invention providing an informational panel 114A, enveloping carrier panel 114B, and card panels 112C and 112D of a blank 100. The enveloping carrier panel 114B is contiguous with each of the informational panel 114A and the card panel 112C with corresponding fold lines 400 defined therebetween, and the card panel 112C is further contiguous with the card panel 112D with a corresponding fold line 400 therebetween. Each of the card panels 112C and 112D includes a waste extraction flap 108 and has been previously die-cut to have a partially cut-out card 102 surrounded by a waste material 110. The card panels 112D and 112C comprise gift cards 102 surrounded by waste material 110 further comprising a waste extraction flaps 108 at the topmost area of the waste material 110. In a nonlimiting example, the enveloping carrier panel 114B includes the fold lines 401 and slits 402 that define a topmost enveloping panel 406, upper middle enveloping panel 405, lower middle enveloping panel 404, and lowermost enveloping panel 403. The middle enveloping panels 404 and 405 are aligned with the partially cut-out cards 102 of the card panels 112C and 112D such that the cards 102 are horizontally aligned with the spaces provided by the enveloping panels 405 and 404 when folded horizontally along the fold lines 400 provided by the production process. The informational panel 114A may be printed and adapted for use in any manner preferred by the retailer or card issuer.

FIG. 11B represents another nonlimiting embodiment of the invention, similarly comprising an informational panel 114A, enveloping carrier panel 114B, and card panels 112C and 112D. In this nonlimiting example, the enveloping carrier panel 114B comprises a lowermost enveloping panel 403, a lower middle enveloping panel 404, and an upper middle enveloping panel 405. This embodiment provides an alternative configuration for folding and securing the enveloping carrier panel 114B. It is anticipated that there can be any variety of folding configurations for the enveloping carrier panel 114B and/or placement locations for the gift card 12 on the enveloping carrier panel 114B requested by consumers, retailers, or issuers.

Subsequent processing steps may commence with step 304 of FIG. 5A, starting with application of the glue pattern 117a and continuing to produce a final promotional product having the double-ply card 12 enclosed between carrier panels A and B. As discussed previously, FIG. 5A shows the glue pattern 117a applied within the partially cut-out card 102 of the card panel 112D, which is the card panel 112D located farthest from the enveloping carrier panel 114B. Optionally, glue 117b may be applied to the waste material 110 of the panel 112D, avoiding the die-cut surrounding its partially cut-out card 102. At step 306 of FIG. 5B, the card panel 112D is folded over and onto the card panel 112C (for example, at one of the folding stations 214 or 216) so that their partially cut-out cards 102 are aligned (superimposed) and glued together with the glue pattern 117a to eventually form a single, multi-ply card 12. Subsequent processing steps may commence with step 301 of FIG. 3B to secure the multi-ply card 12 to the enveloping carrier panel 114B with the glue spots 116, and continuing to produce a final promotional product having the double-ply card 12 enclosed between carrier panels A and B. Notably, because the waste material 110 of the card panels 112C and 112D can be optionally bonded to each other with the glue 117b as a result of the folding step 306, the waste material 110 can be simultaneously removed (e.g., step 322 of FIG. 3E) following removal of the spine 119 (e.g., step 320 of FIG. 3D) formed by the panels 114B, 112C, and 112D, such that all portions of the card panels 112C and 112D are removed other than the bonded partially cut-out cards 102. As the waste materials 110 are removed, any ties 104 securing the partially cut-out cards 102 will tear, leaving the double-ply card 12 on the enveloping carrier panel 114B.

The order and number of such card cutting, folding, and gluing processes will be dependent on the desired final product. In the embodiments of FIGS. 11A and 11B, die cuts to form the partially cut-out cards 102 are performed prior to folding, and can be performed prior to the blank 100 entering the system 200 of FIG. 10 or as one of the initial process steps performed within the system 200. Alternatively, as represented by the embodiments of 11A and 11B, the partially cut-out cards 102 may be formed in the system 200 following a gluing and folding operation, for example, with the use of one or more mid-line die cutters 218, and then followed by one or more additional folding and/or gluing steps.

In view of the foregoing, single and multi-ply partially cut-out cards 102 can be formed in the blanks 100 prior to entering the system 200 of FIG. 10 by die cutting the blanks 100 or an entire multi-up press sheet or web from which the blanks 100 are made to produce multi-ply cards 102, whereas multi-ply partially cut-out cards 102 formed in the blanks 100 within the system 200 of FIG. 10 may be die cut with the use of one or more mid-line die cutters 218 to produce multi-ply cards 12. The mid-line die cutter(s) 218 may be used to die cut single-ply partially cut-out cards 102 while the panels of the blanks 100 are flat, or die cut multi-ply partially cut-out cards 102 after gluing and folding panels of the blanks 100 together into multi-ply thicknesses.

The mid-line die cutter 218 may be any type of die cutter known in the art, such as but not limited to rotary and platen die cutters, or laser, or any other type/method capable of making a complete cut or kiss-cut, the latter referring to a technique in which the die cutter cuts to a specific depth through a substrate (e.g., one or more card panels 112) while leaving an underlying substrate (e.g., carrier panel 114) uncut. The mid-line die cutter 218 may have several locations within the system 200 other than as shown, and may include special modifications such as a sidelay adjustable die-cutting cylinder head and specialty transport sections designed to convey under control individual blanks 100 through the rotary cylinder sections. The mid-line die cutter(s) 218 in the form of a rotary-style die cutter may be specifically designed with any circumference to match any product length with repeat, or non-repeat matching mid-line die cutter designs may employ a motor drive system that operates independently of the main drive of the system 200 and may further utilize an “electronic cam profile” cutting cylinder drive or other nonlimiting electronic and/or mechanical technology. As a nonlimiting example, changeable die cutting cassettes, cylinders or sleeve style designs can be employed to allow changes in the circumferential size of a rotary-style die cutter to meet the conveyance of the blanks 100 by promoting the timing and positional accuracy of the blanks 100 with respect to desired die cut locations on the blanks 100. It is foreseeable that other control and registration techniques such as “dynamic or electronic drive camming” for die cylinder rotary positioning known in the art, could be used to synchronize the die cutter(s) 218 with the blanks 100 as the blanks 100 pass through the die cutter(s) 218 during die cutting of the card(s) 12 or the partially cut-out cards 102 from which they are formed. In the case of a rotary-style die cutter, an independent motor drive system may include separated drive motors for a die cutting cylinder and opposing anvil cylinder, and/or for a conveyance drive carrying the blanks 100 through the die cutter 218. Other types of die cutters commonly used in rotary die cutters include commercially available flexible magnetic die using a magnetic mount die cylinder or a solid-type die screw lockdown style made normally of steel or composite materials. The mid-line die cutters 218 may also be used in multiples to separate x and y axis cutting, and/or portable and moveable and also incorporate functionality to allow the cards 12 to be die cut to any shape or thickness.

According to an aspect of the invention, at least one such mid-line die cutter 218 forms the partially cut-out cards 102 immediately prior to the gluing and folding operation by which a partially cut-out card 102 formed by one or more card panels 112C and 112D is semi-permanently fixed to the one of the panels 114A or 114B prior to removal of the waste material(s) 110. As apparent from the forgoing discussion, such a process may involve any number of card panel gluing and folding processes prior to the die cutting operation, and the die cutting operation may be made through any number of previously folded card panels 112C and 112D (plies).

According to another aspect of the invention, the partially cut-out cards 102 may be formed by the mid-line die cutter(s) 218 after all folding and gluing operations have been performed on the panels 112C, 112D, 114A, and 114B of the blank 100. In such situations, all card panels 112C and 112D to be glued and folded, including the final fold onto the glue spots 116 of the card panel 112C and 112D bearing what will be the partially cut-out cards 102, occurs before any die cutting operation takes place. The cards 12 are only thereafter die cut from the card panels 112C and 112D using the mid-line die cutter 218 set to a specific depth and pressure adjustment to cut through only the card panels 112C and 112D while leaving the underlying carrier panel 114B uncut. Such a kiss-cutting technique eliminates the need to perforate die cut the card panels 112C and 112D immediately prior to the final fold-over of the card panels 112C and 112D at the fold line 400 onto the glue spots 116, and instead the cards 12 are completely separated from the card panels 112C and 112D with a single cut after all folding and gluing operations have taken place.

The use of scores or another technique, such as cut scores or perforations formed by channel, crush, rotary or other methods, is believed to be advantageous to the folding processes within the system 200. Folding accuracy is critical to ensure that the partially cut-out cards 102 and/or card panels 112C and 112D are located in the desired lateral position, especially when multiple partially cut-out cards 102 are to be combined to form a multi-ply card 12. In such situations, initial die placement and scoring position accuracy along the fold lines 400 directly between the card panels 112C and 112D may be of utmost importance. Notably, if the blanks 100 were not previously scored during the blank formation process, it is entirely possible and viable to score the blanks 100 with an appropriate scoring unit included in the system 200 using any process known in the art. As such, scores may be formed within the fold lines 400 on an entire multi-up press sheet, web, or blank 100 at any time or any place while the sheet, web, or blank 100 is flat and yet to be glued and/or folded. Although not required for single-ply card formats, scoring or perforation is typically preferred to provide overall general product quality when folding heavy gauge paper stock. Furthermore, nonlimiting cross directional and diagonal fold lines 401 enables future manual folding of an enveloping carrier panel 114B to create an enveloping carrier panel 114B as shown in FIGS. 11A, 11B, 15 and 16. Such scoring may likely be accomplished using a rotary cylindrical scoring unit as aforementioned within the system 200 near the feed end, and also combined within the die cutting unit 213 at the entry end location either by fixed, repeated scoring matching desired locations of cross directional folding locations or cross scoring shafts using dynamic locating of desired score positions to panel locations as required. Cross directional or diagonal fold lines 401 and slits 402 for closure of the future enveloping carrier panel 114B may be executed at any time or place. Techniques for providing the fold lines 401 and slits 402 are known to those skilled in the art.

Folding operations performed by any one or more of the folding stations 214, 216, 220, and 230 of the system 200 are preferably performed with a plow fold blade designed “down” and the folding panel being folded upward and over. However, the system 200 can be configured for “up” fold orientations, i.e., opposite the prior description, loading and format procedures remain the same and may eliminate blank flopping or turnover. Regardless, methods of production for both “up” and “down” fold orientation are within the scope of aspects of the present invention.

Multi-ply cards 12 of promotional products produced with the system 200 will typically be glued to the enveloping carrier panel 114B during the final folding operation (e.g., at folding station 220) with one or more glue spots 116 or other suitable pattern of a hot melt glue using any gluing system known in the art, such as but not limited to a rotary, mechanical, pattern programmable electronic slot head, extrusion, spray, or other for hot melt or cold glue station.

As described previously, after completion of the final folding of the card panels 112C and 112D, waste materials 110 remain connected to the remainder of the blank 100, which physically connect the card panels 112C and 112D to the enveloping carrier panel 114B.

As previously noted, the optional waste extraction flap 108 provides an additional region of material (e.g., paper) at what becomes the leading edge of the blank 100 as it reaches the waste separation station 226 in the system 200. Because the waste extraction flap 108 extends or protrudes beyond the desired finished length of the enveloping carrier panel 114B, the flap 108 is the first portion of the blank 100 to encounter the waste separation station 226, and therefore can be an effective aid in removal of the waste material 110 from the blank 100 whereby the flap 108 is removed by the waste extraction separation system 226, for example, by a cross-fold-drag-hook-and-lift unit of a type known in the art, or any other mechanical-, electrical-, pneumatic-, and/or vacuum-based technique. Alternatively, if the waste extraction flap 108 is not used, any combination of methods known in the art may be used to remove the waste material 110.

After removal of the waste material 110, the promotional products will comprise one or more cards 12 secured to the enveloping carrier panel 114B as well as the informational panel 114A. Any remaining stations of the system 200 may be configured to finish and convert the remainder of the blank 100 from the flat enveloping carrier panel 114B and informational panel 114A into the final promotional product.

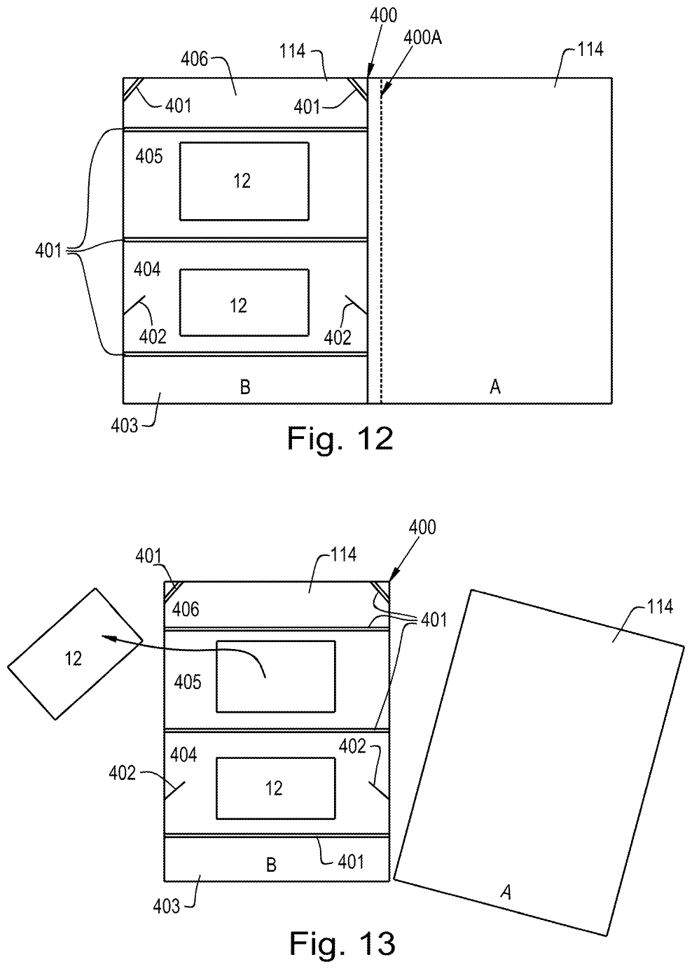

FIG. 12 represents a nonlimiting, non-final closure folded, flat schematic embodiment of an enveloping carrier panel 114B with an informational panel 114A. Gift cards 12 produced are attached to the enveloping carrier panel 114B within the spaces provided by the upper middle enveloping panel 405 and lower middle enveloping panel 404. The promotional product 10 of FIG. 1 is a nonlimiting example of what can be produced by the system 200 of FIG. 10, and may be provided by a retailer or issuer. The informational panel 114A may include, but is not limited to, advertisements, promotional materials, and/or information that facilitates activation or redemption of the gift cards 12.

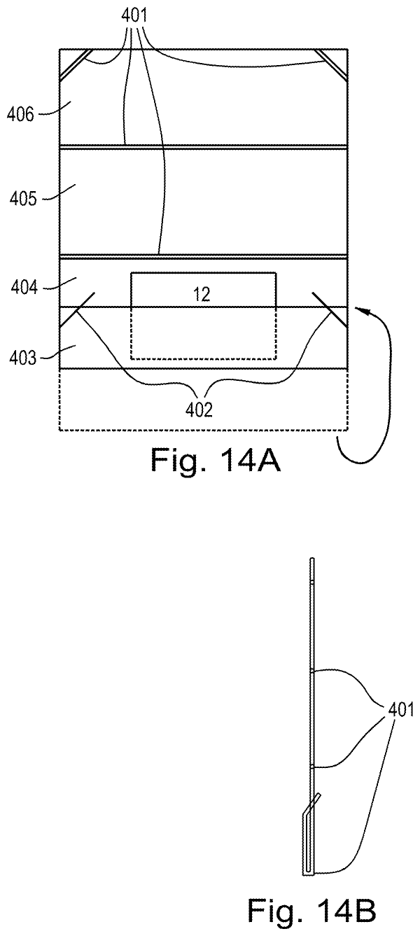

FIG. 13 represents that manual separation between the informational panel 114A and enveloping carrier panel 114B will take place along the fold line 400 provided by the fold lines score 401. Separation is preferably performed by the initial recipient after the promotional product 10 is received thereby. Fold lines may be additionally provided by slits, cut scores, perforated scores, perforations, or any other method known to those skilled in the art. A nonlimiting alternative embodiment provides a secondary line of weakness 400A generally running parallel to the fold line 400 and implementing any above methods of slitting, cut scoring, perforated scoring, or perforations to facilitate removal of the enveloping carrier panel 114B from the informational panel 114A. Any optional panel separation lines of weakness 400A may be included in order to the provide preferred dimensions of the informational panel 114A or enveloping carrier panel 114B.

In an alternative embodiment of the invention, additional panels may be provided from manufacturing from a contiguous blank, in which case the enveloping carrier panel 114B may remain attached to the informational panel 114A and some other panel on its opposite side. In any configuration including additional panels, additional fold lines 400 and lines of weakness 400A along the enveloping carrier panel 114B and/or informational panel 114A may be provided in order to define separate panels and enable effective detachment.

Gift cards 12 being enclosed within the carrier panel 114B may be secured by a nonpermanent adhesive prior to or after folding of enveloping carrier panel 114B before or after detachment of the enveloping carrier panel 114B from remaining informational panel 114A. In the embodiment of the invention of FIG. 11A, gift cards 12 may be secured within the upper middle enveloping panel 405 and lower middle enveloping panel 404. In the embodiment of the invention of FIG. 11B, gift cards 12 may be secured within the lower middle enveloping panel 406. A variety of nonlimiting configurations of attaching the gift cards 12 and enclosing them within the enveloping carrier panel 114B are possible as preferred by the retailer, card issuer or recipient. Any of the cards 12 may be detached at any time, as preferred by the retailer, card issuer or recipient.

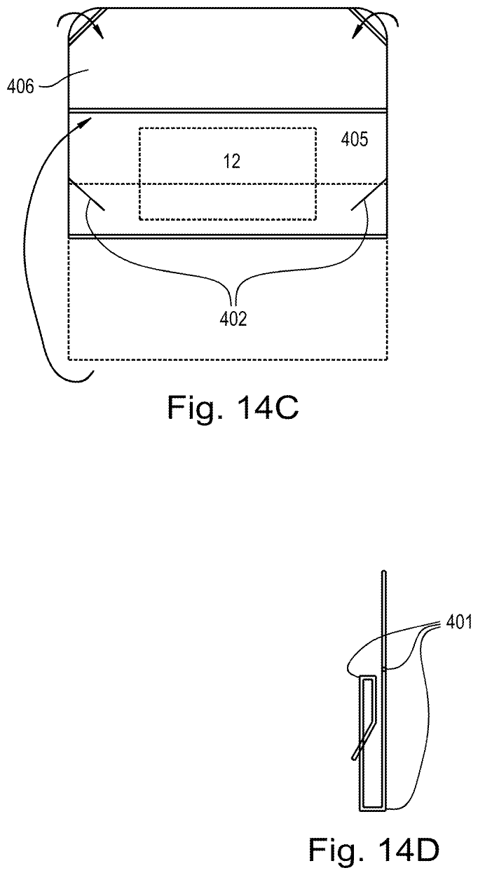

FIG. 13 illustrates a nonlimiting example of use of the promotional product of FIG. 12 by an initial recipient, including removing the upper card 12 (e.g., a secondary promotional/coupon/gift card) from the panel 405 of the enveloping carrier panel 114B, as well as detaching an informational panel 114A from the enveloping carrier panel 114B along a fold line 400 or line of weakness 400A. In a preferred embodiment of the invention, the line of weakness 400A can be formed at initial blanking, cutting, and fold scoring, but may be performed later in the production process. Aforementioned techniques for weakening the fold line 400 with a line of weakness 400A are intended to facilitate clean removal of the informational panel 114A from the enveloping carrier panel 114B. The inclusion of a line of weakness 400A preferably precedes the folding of the enveloping carrier panel 114B as detailed in FIGS. 14A through 14F.

Preferred embodiments of the present invention specifically provide that the cards 12 are activated by the initial recipient and funded with some monetary value, for example, online using an activation website. The initial recipient may thereafter redeem the cards 12 themselves or gift the cards 12 for redemption by another, therefore utilizing the cards 12 as a gift. The advantages of the single printing process of the cards 12, enveloping carrier panel 114B, and informational panel 114A from a single contiguous blank 100 allow information for activation and redemption of such gift cards 12 to be dynamically personalized (e.g., by VDP) by a retailer or card issuer on behalf of a retailer, and placed on the enveloping carrier panel 114B and/or informational panel 114A. By printing and finishing the entire product from a single contiguous blank 100 as a unified product, the initial recipient is better able to activate and redeem the gift card 12 in a more secure and identifiable manner preferred by the retailer or the card issuer, providing economic and marketing advantages without the need for additional sorting, matching, or oversight to ensure information included within the gift cards 12, enveloping carrier panel 114B, and informational panel 114A is consistent for the same recipient or retailer throughout the production process. Furthermore, such information may include unique I.D. dynamic QR codes, UPC, telephone numbers, or other dynamic alphanumeric codes, or NFC and/or RFID devices embedded within plies of the card 12, magnetic strips, or other methods known to those skilled in the art which enable a recipient of the gift card 12 to directly access a preferred website, application, or other means for online activation or redemption from any location wherein the initial recipient has internet access or a cellular device. Such activation and redemption may furthermore include, but is not limited to, providing a telephone number, directing the initial recipient to a retailer's or issuer's call center which thereafter provides card activation and/or redemption services.

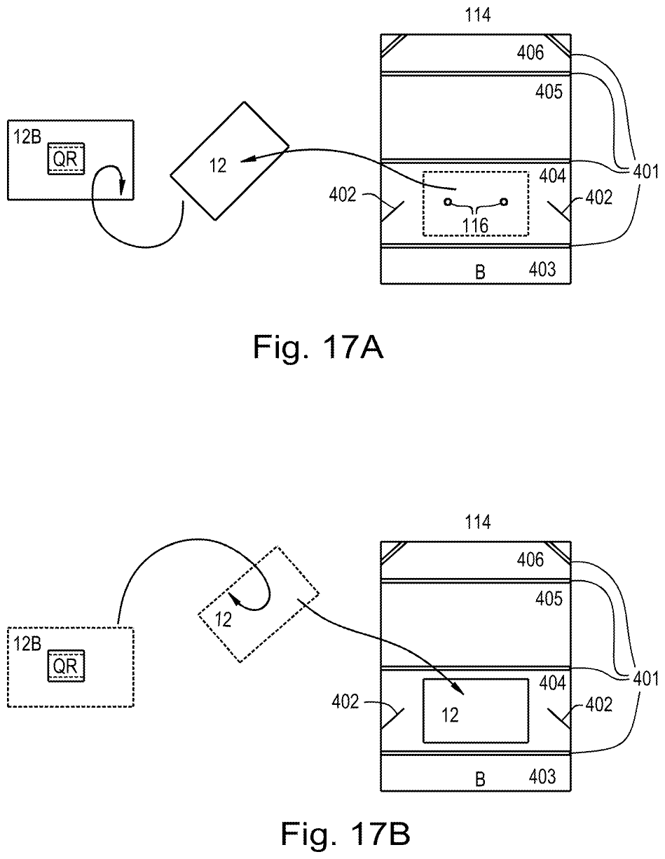

FIGS. 17A and 17B illustrate that ahead of folding one or more gift cards within an enveloping carrier panel 114B for gifting (such as in FIGS. 14A through 14F, or FIGS. 15 and 16), a gift card 12 can be temporarily peeled off or fully exposed from the enveloping carrier panel 114B by an initial recipient or end user of the gift card 12 to capture a unique I.D. QR code with a computer or handheld cellular device, thereby directing the initial recipient or end user to a monetization and activation website through an application or other methods. FIG. 17A represents that following separation of the enveloping carrier panel 114B from informational panel 114A of the product, an initial recipient removes the gift card 12 from the enveloping carrier panel 114B whereby the card 12 is held to the enveloping carrier panel 114B by glue spots 116 (such as a peelable fugitive adhesive) during the original manufacturing process and, as a nonlimiting example, turns the gift card 12 over to expose a VDP unique and dynamically printed and personalized QR or other type barcode, or alphanumeric number or code which is then captured by a cellular or other internet connective method and directed to an application or website where and when the card 12 can be monetized and activated. Following monetization and activation of the card 12, FIG. 17B represents the card 12 optionally placed back onto the enveloping carrier panel 114B in its original location being held in place by the glue spots 116 or any other method described herein such as the card retention slits 402 in the panel 403 (FIG. 11B) or the card retention slits 402 shown on the panels 409 in FIGS. 15 and 16, prior to folding the enveloping carrier panel 114B around the gift card 12 as depicted by the enveloping format examples shown in FIGS. 14A-14F, 15, and 16.

FIG. 14A illustrates a front view of the enveloping carrier panel 114B of the preceding FIGS. 12 and 13 and following detachment from the informational panel 114A. Furthermore, it illustrates a possible embodiment of use of the invention, specifically a first step in folding the enveloping carrier panel 114B into an enclosed configuration, thereby securing a gift card 12 therein. The lowermost enveloping panel 403 folds over, axially along an enveloping fold line 401, partially covering the enclosed gift card 12 with and between the lowermost enveloping panel 403 and the lower middle enveloping panel 404. The corners of the lowermost enveloping panel 403 are placed into the slits 402 provided in the lower middle enveloping panel 404, the slits 402 being provided by the aforementioned production process, thereby securing the lowermost enveloping panel 403 against the lower middle enveloping panel 404. FIG. 14B provides a side view of the same process.

FIG. 14C provides a next step that involves further folding the lower middle enveloping panel 404, along with the gift card 12 enclosed therein and the lowermost enveloping panel 403 secured thereto, axially about an enveloping fold line 401 such that the lower middle enveloping panel 404 contacts the upper middle enveloping panel 405 and is secured thereto. The gift card 12 is therefore enclosed between the lowermost enveloping panel 403, lower middle enveloping panel 404, and upper middle enveloping panel 405. The surface of the lowermost enveloping panel 403 opposite the gift card 12 is therefore in contact with the surface of the upper middle enveloping panel 405 that contacts the gift card 12. Additionally, corners of the topmost enveloping panel 406 as defined by the fold lines 401 may be folded inwards in the same direction as the lowermost enveloping panel 403 and lower middle enveloping panel 404 relative to the upper middle enveloping panel 405. This may be accomplished independent of the folding of the lower middle enveloping panel 404 and lowermost enveloping panel 403. FIG. 14D provides a side view of the same process, showing the preferred sides of contact between the various enveloping panels 403, 404, and 405.

FIG. 14E provides what may be a final step associated with the embodiment of FIGS. 14A-14D, illustrating the topmost enveloping panel 406 being folded axially about a fold line 401 in the same direction as the lower middle enveloping panel 404, lowermost enveloping panel 403, and gift card 12 enclosed therein. The corners of the topmost panel 406, being folded over in the preceding FIGS. 14C and 14D, are thereby aligned with the slits 402 of the lower middle enveloping panel 404. The corners of the topmost enveloping panel 406 may be “dog-ear” folded and slid into the slits 402, thereby securing the topmost panel 406 against the surface of the lower middle panel 404 opposite the enclosed gift card 12. The embodiment in this configuration thereby provides an envelope that fully encloses the gift card 12 therein, and the various enveloping panels 403, 404, 405, and 406 are secured against each other. FIG. 14F provides a side view showing the result of the process represented in FIG. 14E.

Additional fold lines 401 may be provided on the enveloping carrier panel 114B to provide a preferred shape or configuration or to provide volume for additional gift cards 12 or the informational panel 114A folded by a user of the gift card 12 to fit within the area provided by the enveloping carrier panel 114B. Additional slits 402 may be provided in the enveloping carrier panel 114B such that the corners, edges, or some variation thereof of the gift card 12 are secured to any of the enveloping panels 403, 404, 405, or 406 of the enveloping carrier panel 114B, restricting the gift card 12 from moving laterally relative the enveloping carrier panel 114B. In such a configuration, the gift card 12 may not require the use of adhesive to remain secured to and enclosed within the enveloping carrier panel 114B, its movement perpendicular to the plane defined by the enveloping panels 403, 404, 405, and 406 being restricted by the configuration of the enveloping panels 403, 404, 405, and 406 relative to each other, and its translation laterally along the plane defined by the enveloping panels 403, 404, 405, and 406 being restricted by the fold lines 401 of the enveloping panels 403, 404, 405, and 406 and additional slits 402 securing it therein.

FIGS. 14A through 14F describe one possible use of an embodiment of the invention. The processes described therein may be adjusted to facilitate enveloping and securing a gift card 12 enclosed within the product defined in FIG. 12, having two fold lines 401 separating three enveloping panels 403, 404, and 405. Any possible combination or number of enveloping panels, slits 402, and fold lines 401 may be envisioned by a retailer, card issuer, recipient, or end user of the gift card 12 and produced by the methods described previously herein.

FIG. 11B exemplifies a simpler three-panel version of folding the enveloping carrier panel 114B, to contain a card 12, specifically a first step in folding the enveloping carrier panel 114B into an enclosed configuration, thereby securing a gift card 12 therein. The lowermost enveloping panel 403 folds over, axially along an enveloping fold line 401, partially covering the enclosed gift card 12 with the lowermost enveloping panel 403 and the lower middle enveloping panel 404. A next step is to further fold the lower middle enveloping panel 404, along with the gift card 12 enclosed therein and the lowermost enveloping panel 403 secured thereto, axially about an enveloping fold line 401 such that the lower middle enveloping panel 404 contacts the upper middle enveloping panel 405 and is secured thereto. The gift card 12 is therefore enclosed between the lowermost enveloping panel 403, lower middle enveloping panel 404, and upper middle enveloping panel 405. The surface of the lowermost enveloping panel 403 opposite the gift card 12 is therefore in contact with the surface of the upper middle enveloping panel 405 that contacts the gift card 12. An additional horizontal slit 402 is formed on an upper edge of the panel 403 of FIG. 11B, a flap is created by two diagonal slits 402 formed in the panel 405 and, after a final “letterfold” type fold of the panel 405 over the panels 404 and 403, the flap in the panel 405 can engage the horizontal slit 402 in the panel 403 to effect a “latch” closure of the entire three-panel envelope.

It may be desirable that the enveloping carrier panel 114B remains unfolded as a single panel and may omit scores, slits, folds, or modification ordinarily required for gift card display and use aside from detachment from the informational panel 114A. Certain retailers and card issuers may prefer a bi-fold envelope in which the enveloping carrier panel 114B is only folded once to contain the gift card(s) 12 which may remain secured by adhesive or diagonal slits 402 represented on the panel 403 in FIG. 11B or the panel 409 of FIG. 16.

FIGS. 15 and 16 depict additional nonlimiting format examples of the separated enveloping carrier panel 114B whereby the enveloping carrier panel 114B is cut irregularly during the time of blank creation at the top or bottom of the enveloping carrier panel 114B with waste removed from the enveloping carrier panel 114B to define a flap or other type of “latch,” a nonlimiting example of which includes a preformed and protruding edge that can easily and naturally engage a connection point such as a slit or slits on an opposing panel or panels during the enveloping folding process. FIG. 15 represents a three-panel enveloping carrier panel 114B whereby a flap panel 407 is cut at the time of blanking to create a flap or latch. In this example, the gift card 12 is held within a panel 409 with diagonal slits 402 formed therein, and after an initial recipient has monetized and activated the gift card 12 and has manually inserted the card 12 into the slits 402 on the panel 409. The slits 402 that retain the card 12 can also be produced at the time of blanking the entire product. An additional horizontal slit 402 is made in the panel 409 to eventually receive the flap panel 407 upon final closure fold over. The panel 409 is folded along a fold line 401 to meet a panel 408 covering the card 12 ahead of the flap panel 407 being folded down along the fold line 401 where the flap panel 407 inserts into the slit 402 of the panel 409, effectively enclosing the card 12 within the enveloping carrier panel 114B.

FIG. 16 represents a two-panel enveloping carrier panel 114B whereby a panel is cut at the time of blanking to define a curved panel 408. Following activation, the gift card 12 is held within the panel 409 with the slits 402 which are also produced at the time of blanking the entire product. An additional and larger slit 402 is shown as made in the panel 409 to receive the curved panel 408 following a single fold-over along the fold line 401.

The processes described in FIGS. 14A through 14F, 15, and 16 may be further modified such that the various enveloping panels 403, 404, 405, 406, 407, 408, and 409 are secured to each other using adhesive, rather than or in concert with the strategically placed slits 402 described previously. Such an adhesive may be applied during the production process described previously or applied to the contiguous blank 100 prior to processing.

Additionally, the informational panel 114A may be detached, folded, and enclosed within the enveloping carrier panel 114B in any manner preferred by a retailer, card issuer, recipient, or end user of the gift card 12. Alternatively, the informational panel 114A may be provided alongside the gift card 12 enclosed within the enveloping carrier panel 114B. In one nonlimiting example, the informational panel 114A is distributed with or retailed alongside the gift card 12 enclosed within the enveloping carrier panel 114B, and the informational panel 114A describes methods of activation and redemption of the gift card 12, including but not limited to magnetic strips, NFC or RFID devices embedded within plies of the card 12, or unique I.D. dynamic QR codes, other barcodes, telephone numbers or dynamic alphanumeric codes which direct a recipient to website landing pages for activation or online shopping (redemption). Furthermore, the enveloping carrier panel 114B may provide personalized imagery, addresses, or communications to an intended individual recipient as enabled by the aforementioned VDP processes. Any preferred combination or configuration of such printing on the gift cards 12, enveloping carrier panel 114B, and informational panel 114A is enabled and provided for by the methods and processes described herein.

Processes in accordance with aspects described herein are believed to provide improved economic and commercialization benefits deriving from improved manufacturing efficiency relative to conventional promotional material manufacturing, activation, and redemption techniques. Component building and data matching, including but not limited to on-setting and personalization of PVC gift cards contained within or alongside informational panels and enveloping carrier panels containing information (including advertisements) specific to an intended initial recipient and/or retailer, are generally not economically advantageous for small merchants, nor is PVC as environmentally friendly as paper. The production of gift card products is one of the most popular and in-demand promotional methods available to such retailers today with retailers, issuers and end users alike demanding increased convenience and flexibility within the gift card space. Demand is increasing for underserved small businesses to have additional advertisement and downstream gift card options to promote growth.

In a particular but nonlimiting embodiment, a method of distributing and using gift cards 12 produced by any of the processes described above may begin with a retailer or card issuer issuing a promotional product for their business, the product containing but not necessarily being limited to one or more gift cards 12, an envelope, and any pertinent information (for example, advertisements). In this instance, a retailer refers to a commercial entity wishing to expand awareness of and engagement with their organization. A card issuer is generally a source of physical production and issuance with direct affiliation to a third-party required for transaction, redemption and use of the card 12. However, this process may be adapted for use outside of commercial or consumer sectors. The retailer may directly distribute the product via mail or at a point of sale, possibly at a physical retail location, included within a delivery package or in an online purchase or request. The product may be an accessory to a sale for another product or may itself be a product for sale. The initial recipient of the product may activate the gift card 12 at a time and location of their choosing by accessing an online site with their mobile device or computer when engaged with the aforementioned activation methods including but not limited to unique I.D. and dynamic QR codes, UPC, NFC and/or RFID devices embedded with plies of the card 12, magnetic strips, or alphanumeric codes. Upon activation, the initial recipient may directly use the card 12, in which case the initial recipient is the end user of the card 12, or the initial recipient may gift the card 12 to another individual, who is thereby the end user of the card 12. In preferred embodiments, the initial recipient activates the card 12 and gifts the card 12 to another who becomes a new customer of the retailer, thereby expanding market awareness of the retailer and potentially expanding to new returning customers.

In aforementioned embodiments of the invention, the gift card 12 may be provided to but never activated by the initial recipient if that person does not wish to do so, therefore absolving the retailer or issuing party of issuing monetary value to uninterested recipients. The retailer or issuing party may also provide activation methods that allow the initial recipient to activate and monetize the card 12 with a gift value prior to gifting the card 12 to an end user of the card 12. In this manner, existing customers, serving as the initial recipient, may provide monetary value directly to potential new customers, thereby providing a grass-roots level means of customer-based expansion. In such a case, an entire advertising mail product containing one or more cards 12 may be received via point of sale at a physical retail location. Conversely, a large retailer with a sizeable online footprint and multiple physical locations may mail such products, including gift cards 12, as part of an advertisement to potential customers or known initial recipients, as determined by business analytics, and as decided by organizational leadership of the retailer. In such an embodiment, the present invention may be capable of providing advantages to both small businesses and large corporate retailers.

In certain circumstances the product may be issued with “preloaded” value wherein the issuer loads a value to the card 12 which is redeemable without an authorization or monetization step by the initial recipient. A business may issue the product with a gift card 12 as bonus to their employees for example, in which case the initial recipient and/or end user redeems the value of the card 12 at one or more selected retailers, while a benefit to the business may be a cost reduction to the purchase redeemable value.

In one possible embodiment of using the cards 12, the initial user removes the card(s) 12 from the product, such as a brochure. The first card carrier panel 114B is detached from the entire brochure, and then folded along the fold (cut or scored) lines 401, folded and clasped closed panel to panel using the die cut slits 402 to form an envelope with the gift card 12 disposed inside. The initial user may choose to validate the card 12, for example by loading some monetary value to the card 12 via a computer-based internet online validation system. The validated gift card 12 is enclosed within the envelope and gifted or otherwise transferred to a final recipient (the end user) of the card 12.

In some embodiments, the product (e.g., brochure) and its card(s) 12 are printed with an individual or multiple small business advertisement and the corresponding small businesses offer card(s) 12 which include variable data and barcode identifiers specific to a particular recipient. When the barcode is scanned by a QR or UPC capture device, the device automatically drives the end user to a specific URL or PURL website, mobile computer software application, on any other computer-implemented system where any desired additional actions can then be implemented as configured into the computer application.

For example, in one contemplated configuration, the URL or PURL to which the end user is directed via a unique I.D. QR or barcode, allows the brochure/card recipient to choose to activate and/or validate the particular card 12 for a gift amount using a credit card or other payor account. Once the card 12 is validated or enabled with a value, the card 12 is packaged into the envelope as previously described and gifted to the end user. When the end user uses the card 12, it will drive the end user to the retailer, such as at a brick-and-mortar retail location or online retail site, at which a final scan of the barcode will initiate redemption of the gifted amount.

The present invention provides advantages to printing, finishing, and converting such promotional products by combining the advantages conferred by dynamic VDP-derived advertising and promotional materials whereby a complex and highly developed combination advertisement and financial services product is manufactured in a data secure and single pass process from a contiguous blank, thereby gaining efficiencies in production and oversight while allowing sophisticated, streamlined and consumer directed methods of packaging, distribution, activation, redemption and use, all while retaining significant economic advantages by gaining efficiencies and reduced material costs derived from the same processes. Alternative methods for low quantities involve costs to purchase cards separately, on-serting cards onto carriers, costs for additional/multiple printing processes, limited creativity in card placement or design, additional read/write VDP/encoding, camera/verification systems, costs, etc., making those alternatives very costly as well. Processes in accordance with preferred aspects of the invention are believed to provide a major economic advantage over conventional printing and card-finishing production methods for printing quantities as low as about ten pieces, with the greatest economic benefits believed to be achieved in printing quantities between about 1000 to 200,000 pieces.

While the invention has been described in terms of specific embodiments, it is apparent that other forms could be adopted by one skilled in the art. For example, the physical configuration of products produced by processes described herein could differ from the products 10 depicted in the drawings, and the physical configurations of the system 200 and its stations and units could differ from those shown in the drawings, functionally equivalent equipment could be substituted for the units and equipment described, and materials and processes other than those noted could be used. As such, and again as was previously noted, it should be understood that the invention is not necessarily limited to any particular embodiment described herein or illustrated in the drawings.

1. A process of manufacturing a promotional product comprising at least a first informational panel, enveloping carrier panel, and at least one card secured thereto, the process comprising:
providing a single, individual contiguous blank having VDP images or text printed thereon, the blank comprising more than one panel including at least a first card panel, at least a first enveloping carrier panel, and at least a first informational panel, the first card panel and the first enveloping carrier panel being contiguous along a fold line therebetween and the first enveloping carrier panel and first informational panel being contiguous along a fold line therebetween;
cutting the first card panel to at least partially define a first partial cutout card therein such that the first partial cutout card remains partially attached to the first card panel and a first remaining portion of the first card panel surrounds the first partial cutout card;
folding the first card panel over and onto the first enveloping carrier panel such that the first partial cutout card is secured to the first enveloping carrier panel with an adhesive;
removing the first remaining portion of the first card panel so that the first remaining portion is separated from the first partial cutout card, the first partial cutout card remains secured to the first enveloping carrier panel and defines at least a portion of the card of the product, and the first enveloping carrier panel defines at least a portion of the enveloping carrier panel of the product;
wherein at least the card, the enveloping carrier panel, and the first informational panel are never physically separate or out of contact with one another throughout the process.

2. The process of claim 1, wherein the fold line between the enveloping carrier panel and the first informational panel comprises a perforation, cut, score, cut score or slit to create a line of weakness whereby the enveloping carrier panel including the card is easily detached from the first informational panel.

3. The process of claim 1, wherein the enveloping carrier panel is scored, perforated, or slit to create additional fold lines to facilitate secondary folding of the enveloping carrier panel to form an envelope containing the card.

4. The process of claim 1, wherein the entire product, comprising the first informational panel, the enveloping carrier panel, and at least the card attached to the enveloping carrier panel, is received by an initial recipient, the initial recipient thereafter detaching the enveloping carrier panel with at least the card attached thereto from the first informational panel and folding the enveloping carrier panel such that the enveloping carrier panel envelopes and secures at least the card therein.

5. The process of claim 1, wherein means for activating and/or redeeming the monetary value of the cards is provided on the enveloping carrier panel, the card, and/or the first informational panel.

6. The process of claim 1 wherein the card is activated for monetary value by an initial recipient at any time prior to enclosing and securing the card within the enveloping carrier panel.

7. The process of claim 1, wherein the card is monetized and activated by an initial recipient for redemption of some monetary value at an out of store location prior to enclosing and securing the card within the enveloping carrier panel.

8. The process of claim 7, wherein monetization, activation and redemption of the card are authorized and maintained on behalf of a retailer by a card issuer or other third-party.

9. The process of claim 8, wherein at least the card is pre-loaded with value or monetized by the card issuer on behalf of the retailer or an issuing business and the initial recipient prior to distribution.

10. The process of claim 7, wherein activating and/or redeeming the monetary value of the card include the use of card issuer-provided websites, applications, or telephone numbers to activate and/or redeem the card prior to enclosing and securing the card within the enveloping carrier panel.

11. The process of claim 7, wherein activating and/or redeeming the monetary value of the card include VDP unique I.D. and dynamic Quick Response (QR) Codes, UPC type barcodes, magnetic strips, alphanumeric number sequences, NFC or RFID type electronic tags that are visible or concealed on or within the card, or means for enabling card activation and redemption using a computer, telephone or mobile device to enter or scan codes and access telephone call centers, online websites, or applications.

12. The process of claim 4, wherein instructions for folding and securing the card within the enveloping carrier panel are printed on the enveloping carrier panel and/or the informational panel.

13. The process of claim 4, wherein following card activation, the initial recipient chooses to omit securing the card within the enveloping carrier panel and redeems or gifts the card directly.

14. The process of claim 1, wherein the blank comprises a second card panel contiguous with the first card panel and having a second fold line therebetween, the process further comprising:
folding the second card panel over and onto the first card panel such that the second card panel is secured to the first card panel with an adhesive, wherein the card comprises at least two plies, a first of the plies is the first partial cutout card of the first card panel, and a second of the plies is a second partial cutout card of the second card panel.

15. The process of claim 14, wherein the cutting step comprises cutting each of the first and second card panels to define the first and second partially cutout cards therein that remain partially attached to the first and second card panels, respectively, the cutting step is performed prior to folding the first card panel over and onto the second card panel, and the first and second partially cutout cards are bonded to each other as a result of the folding step.

16. The process of claim 14, wherein the first and second card panels are bonded to each other as a result of the folding step, the cutting step is performed after folding the first card panel over and onto the second card panel, and the cutting step comprises simultaneously cutting the first and second card panels to define the first and second partially cutout cards therein.

17. The process of claim 14, wherein the cutting step comprises cutting each of the first, second, and third card panels to define the first, second, and third card partially cutout cards therein that remain partially attached to the first, second, and third card panels, respectively, the cutting step is performed prior to folding the first card panel over and onto the second card panel and second card panel onto third card panel, and the first, second, and third partially cutout cards are bonded to each other as a result of the folding step.

18. The process of claim 14, wherein the blank comprises a third card panel contiguous with the second card panel and having a fold line therebetween, the process further comprising:
folding the third card panel over and onto the second card panel and gluing the third card panel to the second card panel with an adhesive, wherein the card comprises a plurality of plies, a first of the plies is the first partial cutout card of the first card panel, and a second of the plies is a second partial cutout card of the second card panel and a third of the plies is a third partial cutout card of the third card panel.

19. The process of claim 18, wherein the first, second, and third card panels are bonded to each other as a result of the gluing and folding step, the cutting step is performed after folding the first card panel over and onto the second card panel, and the cutting step comprises simultaneously cutting the first and second card panels to define the first and second partially cutout cards therein.

20. The process of claim 3, wherein the fold lines within the enveloping carrier panel are produced by scoring, cut scoring, slitting or perforation.

21. The process of claim 3, wherein the enveloping carrier panels of the enveloping carrier panel are secured to each other once folded onto each other by slots produced and strategically placed in the enveloping carrier panels such that the edges and/or corners of various panels align, once folded, with the slots produced in adjacent panels and are inserted into such slots, thereby securing adjacent panels onto each other.

22. The process of claim 3, wherein the enveloping carrier panel envelopes a card and the enveloping carrier panels are secured to each other using adhesive

23. The process of claim 1, wherein any of the card, the enveloping carrier panel, or the first informational panel provide matching VDP unique I.D. and dynamic initial recipient or user-specific data information, including demographic, geographic or purchase history-based offers, advertisement, points of contact, addresses, graphics, or decorative elements.

24. The process of claim 1, wherein after the card is monetized and activated by the initial recipient, the initial recipient gifts the envelope with the card attached therein to an end user.

25. The process of claim 24, wherein the end user redeems at least one card online or at a physical retail store.

26. The process of claim 1, wherein the first informational panel and/or enveloping carrier panel with the card attached therein is distributed to an initial recipient via direct mail.

27. The process of claim 1, wherein the first informational panel and/or enveloping carrier panel with the card attached therein is distributed to an initial recipient at a physical retail store.

28. The process of claim 1, wherein the first informational panel and/or the enveloping carrier panel with the card attached therein is distributed to an initial recipient via inclusion with shipment of purchased goods or services.

29. A system for manufacturing a promotional product comprising an informational panel, enveloping carrier panel, and at least one card attached thereto, the system comprising:
means for providing a blank having images, text, VDP unique I.D. dynamic Quick Response (QR) or UPC type codes, NFC devices, RFID devices, magnetic strips or alphanumeric codes printed or applied thereon, the blank comprising more than one panel including at least a first card panel, at least a first enveloping carrier panel, and at least a first informational panel, adjacent panels being contiguous with fold lines therebetween;
means for cutting the first card panel to at least partially define a first partial cutout card therein such that the first partial cutout card remains partially attached to the first card panel and a first remaining portion of the first card panel surrounds the first partial cutout card;
means for folding the first card panel over and onto the first enveloping carrier panel such that the first partial cutout card is secured to the first enveloping carrier panel with an adhesive;
means for removing the first remaining portion of the first card panel so that the first remaining portion is separated from the first partial cutout card, the first partial cutout card remains secured to the first carrier panel and defines at least a portion of the card of the product, and the first enveloping carrier panel defines at least a portion of the carrier of the product;
means for scoring the enveloping carrier panel such that fold lines are defined on the enveloping carrier panel which further define enveloping panels on the enveloping carrier panel that, when the enveloping carrier panel is detached from adjacent panels, fold onto each other thereby enclosing a space in between; and
means for slitting the enveloping panels of the enveloping carrier panel such that the edges or corners of the enveloping panels align with the slots provided in adjacent pairs of the enveloping panels and fitted through said slots, thereby securing the adjacent pairs of the enveloping panels to each other.
